(19) United States
(12) Patent Application Publication
(10) Pub. No.: US 2026/0290867 A1
(43) Pub. Date: Sep. 24, 2026

(54) FREE-RADICAL PROTECTED MEMBRANES

(71) Applicant: CELADYNE TECHNOLOGIES, INC., Chicago, IL (US)

(72) Inventors: Erin Castele, Westlake, OH (US); Toru Hatsukade, Evanston, IL (US); Corey Staller, Boise, ID (US); Gary Ong, Temecula, CA (US); Dana A. Kazerooni

(21) Appl. No.: 19/476,286

(22) PCT Filed: Apr. 18, 2024
(86) PCT No.: PCT/US24/25138

§ 371 Date: Oct. 17, 2025

Related U.S. Application Data
(60) Provisional application No. 63/460,413, filed on Apr. 19, 2023.

(51) Int. Cl. H01M 8/1032; H01M 8/10; H01M 8/1004; H01M 8/1039; H01M 8/1069

(52) U.S. Cl. CPC H01M 8/1032; H01M 8/1004; H01M 8/1039; H01M 8/1083; H01M 2008/1095

(57) ABSTRACT

The present disclosure relates to a polyelectrolyte membrane, comprising a polyelectrolyte and a metal complex, wherein: the metal complex comprises a metal cation and a ligand; and the ligand comprises three or more functional groups, wherein each functional group is independently selected from phosphonic acid, sulfonic acid, and carboxylic acid, or an anion thereof. The present disclosure further relates to methods of making the polyelectrolyte membrane, as well as membrane electrode assembly and fuel cell comprising the polyelectrolyte membrane.

### RELATED APPLICATIONS

This application claims the benefit of priority to U.S. Provisional Application No. 63/460,413 filed Apr. 19, 2023. The entire teachings of the above application are incorporated herein by reference.

### BACKGROUND OF THE INVENTION

Proton exchange membrane-based fuel cells (PEMFCs) are eco-friendly energy conversion devices that operate at low temperatures and are more efficient than existing internal combustion engines. With these advantages, PEMFCs have emerged as a popular alternative to fossil fuels in the transportation industry and have the potential for use in a wide range of applications, such as portable devices and stationary power supply systems.

The proton exchange membrane (PEM) which conducts protons and serves to separate the cathode and the anode is an essential element of a PEMFC. PEMs significantly affect the overall performance of fuel cells; thus, improving the efficiency of a fuel cell requires a PEM that has high ionic conductivity, low fuel crossover, and provides high physicochemical and mechanical stability. Because PEMFCs use a thin membrane as the electrolyte, these devices are more portable and compact than other types of fuel cells. However, the thin membrane can also allow the crossover of the fuel gas (hydrogen), which negatively affects the cell efficiency. Further, the PEM materials are susceptible to deterioration due to the presence of free radicals such as HO^{●} and HOO^{●} that are formed on the electrodes, particularly when hydrogen crossover is present. Accordingly, PEMs with high ionic conductivity, reduced hydrogen crossover, and stability with respect to radical oxidants are needed.

### SUMMARY OF THE INVENTION

In a first embodiment the present disclosure relates to a polyelectrolyte membrane, comprising a polyelectrolyte and a metal complex, wherein: the metal complex comprises a metal cation and a ligand; and the ligand comprises three or more functional groups, wherein each functional group is independently selected from phosphonic acid, sulfonic acid, and carboxylic acid, or an anion thereof.

In a second embodiment, the present disclosure relates to a method of making the polyelectrolyte membrane described herein with respect to the first embodiment and various aspects thereof, the method comprising (a) providing a casting surface and a suspension comprising a metal complex, a polyelectrolyte, and (i) a crosslinking reagent, and/or (ii) a crosslinking initiator; (b) depositing the suspension on the casting surface, thereby providing a membrane layer; and (c) exposing the membrane layer to conditions sufficient for (i) the polyelectrolyte and the crosslinking reagent to undergo a crosslinking reaction, or (ii) the crosslinking initiator to initiate the crosslinking of the of the polyelectrolyte, thereby providing the polyelectrolyte membrane.

In a third embodiment, the present disclosure relates to a method of making the polyelectrolyte membrane described herein with respect to the first embodiment and various aspects thereof, the method comprising (a) providing a porous matrix and a suspension comprising a metal complex and a polyelectrolyte; (b) contacting the porous matrix with the suspension, thereby providing an impregnated porous matrix; and (c) drying the impregnated porous matrix, thereby providing the polyelectrolyte membrane.

In a fourth embodiment the present disclosure relates to a membrane electrode assembly (MEA), comprising a polyelectrolyte membrane described herein with respect to the first embodiment and various aspects thereof; a cathode; and an anode, wherein the polyelectrolyte membrane is disposed between the anode and the cathode.

In a fifth embodiment the present disclosure relates to a fuel cell, comprising one or more of the MEAs described herein with respect to the fourth embodiment and various aspects thereof and one or more gas flow bipolar plates.

### BRIEF DESCRIPTION OF THE DRAWINGS

FIG. 1 shows a schematic depiction of the free radical scavenging (FSR) mechanism in hydrocarbon membranes, e.g., sulfonated polyphenyl sulfone (sPPS or sPPSU).

FIG. 2 shows chemical structures of aminotris(methylphosphonic acid) (ATMP) and a complex comprising Ce cation, ATMP as the ligand, and NO₃⁻ as the complex anion.

FIG. 3 is a bar graph demonstrating Ce retention in perfluorosulfonic acid (PFSA) membrane after 250 hours of accelerated stress testing as characterized by x-ray fluorescence spectroscopy.

FIG. 4 is a bar graph demonstrating enhanced chemical durability of sPPS membrane with Ce(ATMP) complex additive as compared to an additive-free sPPS membrane or a membrane comprising Ce nitrate, as measured by a Fenton reagent test.

FIG. 5 is a bar graph demonstrating relative remaining weight of a crosslinked sPPS membrane with Ce(ATMP) complex additive (1 wt. % Ce loading) after 48 hour Fenton reagent test at 80° C., depending on ratio of Ce to ATMP.

FIG. 6 is a bar graph demonstrating relative remaining weight of a crosslinked sPPS membrane with Ce(ATMP) complex additive (1 wt. % Ce loading) after 48 hour Fenton reagent test at 80° C., depending on Ce oxidation state.

FIG. 7 is a bar graph demonstrating relative remaining weight of a crosslinked sPPS membrane with Ce(ATMP) complex additive (1 wt. % Ce loading) after 48 hour Fenton regent test at 80° C., depending on the acid employed in the synthesis of the Ce(ATMP) complex.

FIG. 8 shows single cell polarization and power curves of membranes prepared with Nafion™ 212 (N212) and crosslinked sPPS.

FIG. 9 is a plot demonstrating hydrogen crossover of N212, Nafion™ 117 (N117), and crosslinked sPPS.

FIG. 10 shows polarization curves of 8 μm-thick PFSA D2020 (D2020) membranes comprising 1.4 mol % of Ce complex with various ligands.

FIG. 11 is a plot demonstrating hydrogen crossover of 8 μm-thick D2020 membranes comprising 1.4 mol % of Ce complex with various ligands.

FIG. 12 shows polarization curves of 8 μm-thick D2020 membranes comprising 1.4 mol % of Co, Cu, Ni, or Fe complex with ATMP ligand.

FIG. 13 is a plot demonstrating hydrogen crossover of 8 μm-thick D2020 membranes comprising 1.4 mol % of Co, Cu, Ni, or Fe complex with ATMP ligand.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION OF THE INVENTION

A description of example embodiments of the invention follows.

Incumbent PEM technology is dominated by perfluorosulfonic acid (PFSA) polyelectrolytes that combine a polytetrafluroethylene (PTFE) backbone with sulfonic acid side groups. PFSA materials suffer from a variety of drawbacks including insufficient membrane durability for heavy-duty fuel cells, expensive ionomer costs, and a threat of regulatory limitations that may exacerbate cost concerns or fully outlaw usage. Sulfonated hydrocarbon membranes are a promising alternative to PFSA, particularly those based on polymers with existing supply chains. Sulfonated hydrocarbon membranes offer a route toward decreased membrane prices and a more robust supply chain in the hydrogen economy.

Hydrocarbon membranes historically suffer from substantial swelling, insufficient conductivity, water solubility, or insufficient durability. Most notable of these concerns is low chemical durability as a result of the damage caused by free radicals forming in side reactions after gas crossover. Prior work has shown that hydrocarbon membranes are substantially more sensitive to radical attack than PFSA membranes due to more facile radical attack reaction (~10⁶ M⁻¹s⁻¹ for PFSA compared to ~10⁹-10¹⁰ M⁻¹s⁻¹ for aromatic rings in hydrocarbon membranes). These processes are accelerated under aggressive heavy duty load cycles where higher power requirements result in higher device temperatures. After membrane and ionomer degradation, the acidic byproducts lead to further degradation of bipolar plates and catalyst layers, while further accelerating the membrane degradation. In short, fuel cell durability is intimately linked with membrane durability, and the latter is dictated by gas permeability and resistance to radical attack.

Two principal approaches have been investigated to improve hydrocarbon membrane durability, namely i) using hydrocarbon polymers with hyperbranched aromatic rings and ii) the addition of free radical scavengers (FRSs) into the membrane.

The first approach seeks chemical durability using hyperbranched aromatic polymers, such as sulfophenylated-polyphenylene. These systems are able to successfully replicate PFSA performance in swelling, conductivity, and polarization performance while also demonstrating hydrogen crossover about 20-30% lower than PFSA. While sulfophenylated-polyphenylene recently achieved the DOE heavy-duty durability target in accelerated stress tests (AST), these polymers remain susceptible to oxidizing and radical attack. Sulfophenylated-polyphenylene loses up to ~80% of its weight when immersed in 1% H₂O₂ at 80° C. for just 24 hours with even more degradation when subjected to a Fenton reagents test. Such concerns motivate research into further increasing hydrocarbon membrane durability.

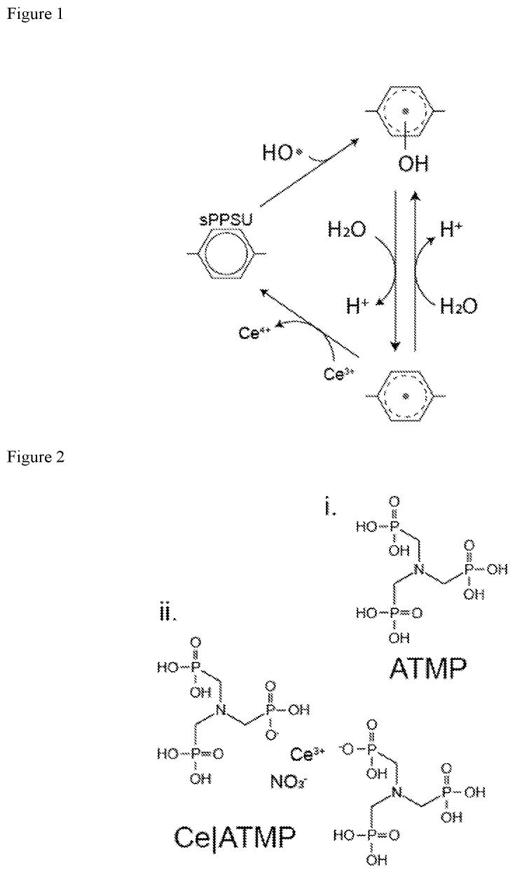

The second approach incorporates redox active species either in the membrane or catalyst layer as FRSs. The additives can range from molecular species like Ce and Mn compounds or related metal oxides like CeO₂ and MnO₂ introduced either by cation exchange reactions, sol-gel synthesis, or simple addition. It is hypothesized that the metal redox couple scavenges the formed aromatic radical rather than the hydroxyl radical directly. This prevents ring destructive secondary reactions, which are significantly slower (10²-10⁵ M⁻¹s⁻¹), making free radical scavengers an effective strategy to protect hydrocarbons from radical induced decomposition (FIG. 1). Incorporation of cerium-based FRS additives into hydrocarbon membranes, such as cerium chloride in sulfophenylated-polyphenylene with biphenyl linker (sPPB), exhibits significant improvements to membrane durability including up to a 3× increase in sPPB weight retention after 24 hours immersion in 80° C. 1% H₂O₂. However, these effects are temporary due to metal oxide dissolution or cation migration out of the membrane.

Hydrogen crossover is an undesirable diffusion of hydrogen from the anode to the cathode through the membrane in a fuel cell. Hydrogen crossover can have at least three effects, including fuel efficiency reduction, cathode potential depression, and aggressive peroxide radical formation. The hydrogen which crosses over can directly react with oxygen at the cathode surface, resulting in a lower cathode potential than that of a lower fuel cell. More impactfully, this direct reaction between H₂ and O₂ at the cathode can produce peroxide radicals, which not only attack the catalyst layer but also the membrane, causing significant catalyst-layer and membrane degradation. In addition, it has been confirmed that the formation of hot-points or hydrogen peroxide by the highly exothermal chemical reaction between H₂ and O₂ can also lead to pinholes in membranes, destroying the MEA and causing safety problems. An accelerated sintering of catalysts can also be caused by this hydrogen crossover. The presence of adventitious Cu and Fe further catalyze the breakdown of H₂O₂ into reactive oxygen radicals. To address this root cause, membranes can be made more durable by introducing FRSs in the membranes. In some embodiments, the present disclosure demonstrates that insoluble complexes of reducible metals can serve as FRSs in PEMs.

In some embodiments, the present disclosure demonstrates that water-insoluble metal complexes exhibit persistent free radical scavenging in PEMs. The FRSs of the present disclosure protect both hydrocarbon and PFSA membranes from radical attack, remain insoluble in PEM fuel cell conditions, and are redox active additives. The insoluble FRS is incorporated into hydrocarbon membranes to confer radical attack protection to the underlying hydrocarbon.

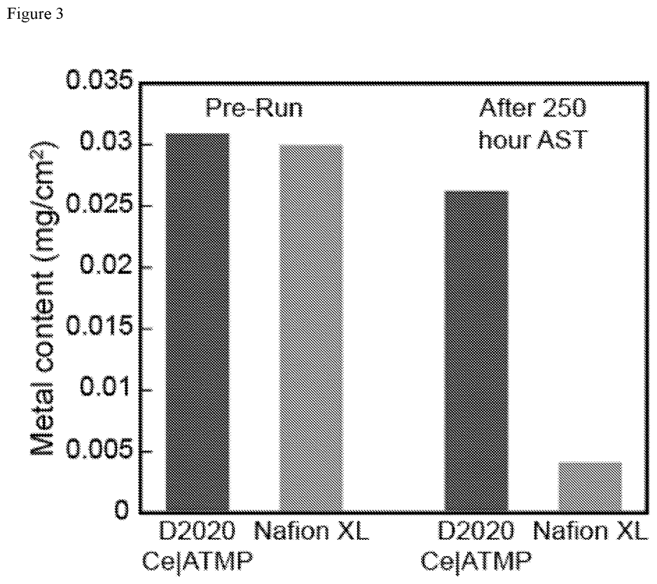

Cerium species, such as cerium nitrate or cerium oxide, are frequently used as FRS additives in PEM membranes to improve membrane durability. However, they are susceptible to etching and leaching, limiting efficacy. Complexation of a metal, such as cerium, with a ligand comprising multiple functional groups, e.g., a tridentate, tetradentate, pentadentate, or hexadentate ligand, yields a water insoluble complex that persists in acidic environments. Insolubility of such complexes prevents cerium migration after 250 hours under accelerated stress test (AST) conditions in PFSA membranes, addressing a major downside of conventional cerium additives (FIG. 3).

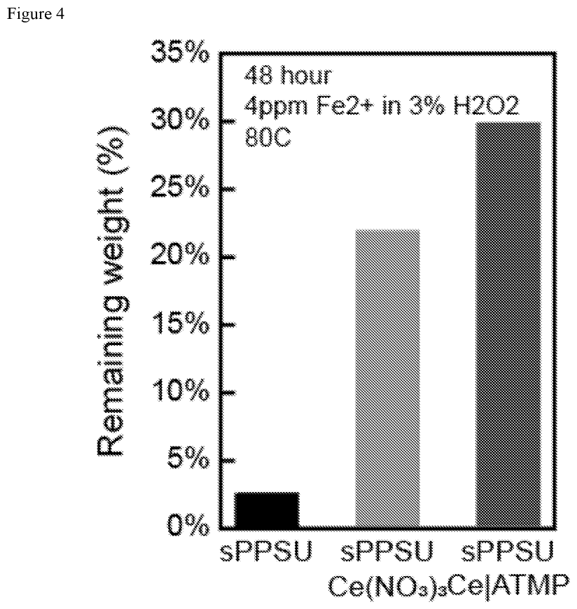

In some embodiments, the membrane containing Ce and aminotris(methylphosphonic acid) (ATMP) (FIG. 2) demonstrated durability of more than 3-fold the value for baseline Nafion® XL (containing conventional Ce salt FRS). In some embodiments, the membranes of the disclosure demonstrated increased material retention following a 48 hour exposure to Fenton reagent at 80° C. (FIG. 4). The control sample crosslinked sulfonated polyphenyl sulfone (sPPS) membrane with no FRS additive was almost entirely digested while sPPS with 1 wt. % Ce as cerium nitrate or Ce(ATMP) complex retained 20% and 30% of the initial membrane. Ce(ATMP) complex+sPPS retained 10 times more material than the control and 33% more than cerium nitrate+sPPS, indicating that Ce(ATMP) complex is an effective FRS additive to protect hydrocarbons from radical attack.

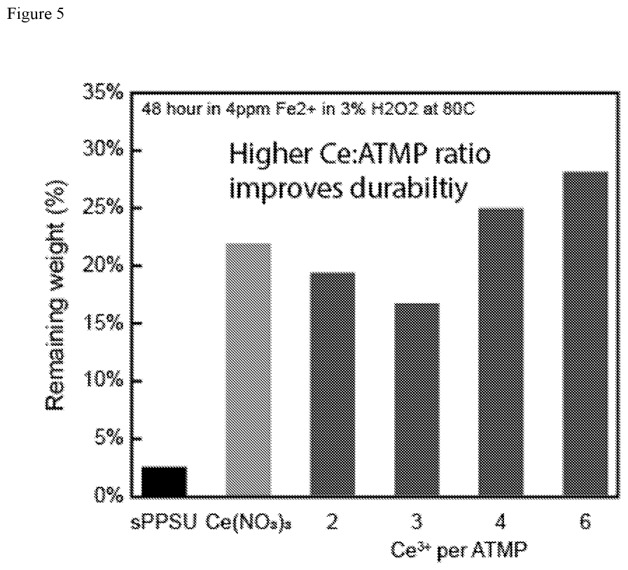

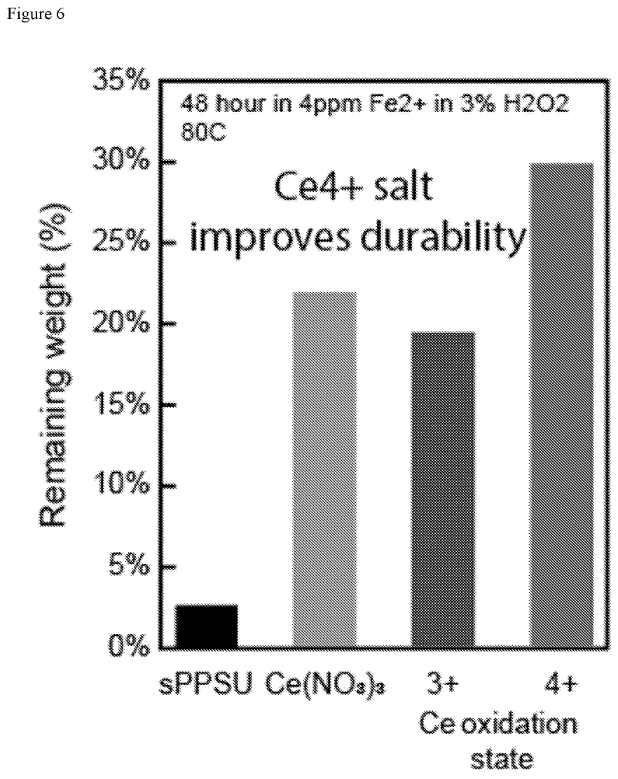

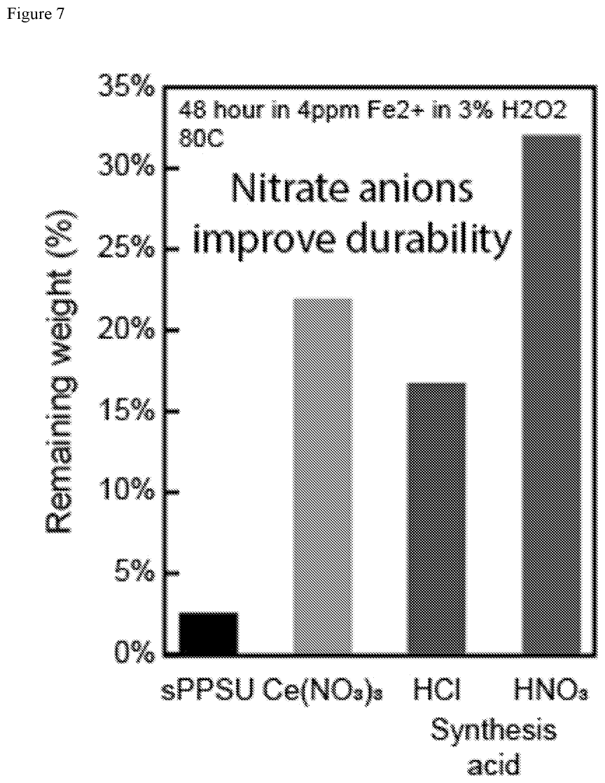

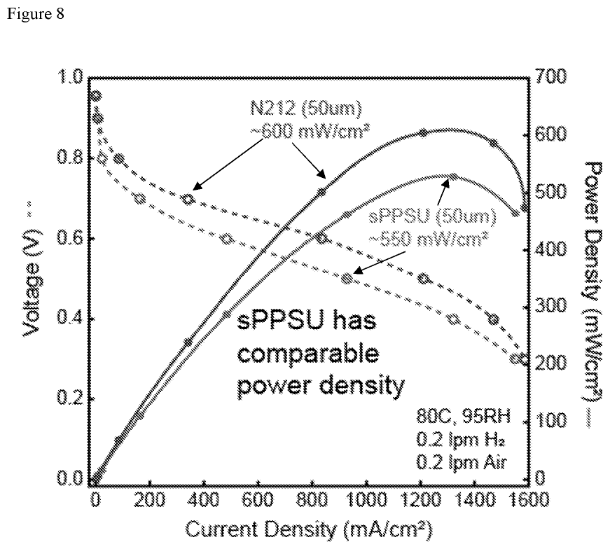

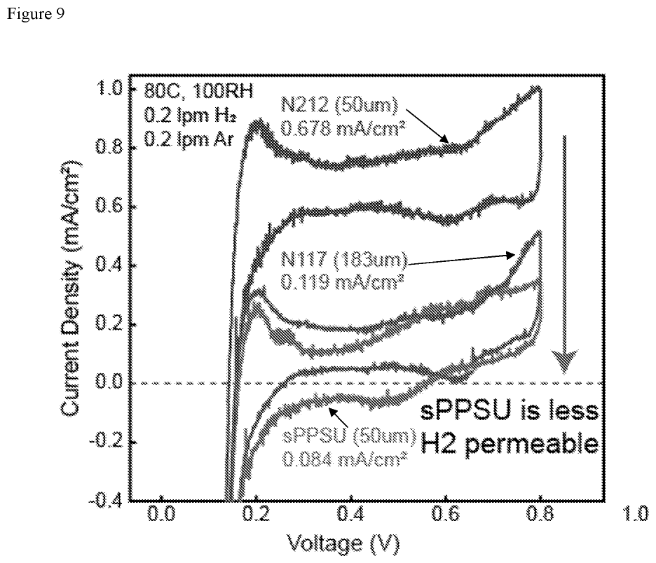

In some embodiments, the present disclosure describes a highly tunable synthesis for Ce(ATMP) complexes with facile free radical scavenging capabilities (FIGS. 5-7). Ce(ATMP) complexes are tunable by Ce to ATMP ratio (FIG. 5), Ce oxidation state (FIG. 6), and Ce secondary counterion, also referred to as complex anion (FIG. 7). Membranes comprising sPPS+Ce(ATMP) complex (1 wt. % Ce) exposed to Fenton test demonstrate significantly different material retention depending on the Ce(ATMP) species introduced and, in most cases, higher material retention than with cerium nitrate. These tests unexpectedly show that chemical durability of a Ce(ATMP)-containing membranes depends on such parameters as Ce to ligand ratio, Ce oxidation state, and the nature of the complex anion.

In some embodiments, the present disclosure further contemplates preparation of composite membranes comprising sPPS+Ce(ATMP) complex for evaluation of conductivity and Fenton reagent test stability. In some embodiments, Ce(ATMP) complex additives are synthesized with various Ce formal charges, Ce:ATMP ratios, and Ce anions before integration into sPPS inks at Ce(ATMP) complex loadings of 0.5, 1, 3, 5, 7 wt. % Ce. Ce species uniformity and oxidation state are evaluated by energy dispersive x-ray analysis and x-ray photoelectron spectroscopy, respectively, to ensure uniform distribution of redox active species.

In some embodiments, Ce(ATMP) complex may form grains too large to be evenly distributed throughout membrane. Mortar and pestle, ultrasonication, and extended ink agitation can be used to improve membrane uniformity. Alternatively, adjusting synthesis concentration is evaluated to achieve smaller grains.

In some embodiments, blade coating is used to scale up the supported hydrocarbon membrane casting. Solutions comprising sPPS+Ce(ATMP) complex are used to cast membranes into a porous PTFE support to determine the influence of blade thickness, casting speed, and solution concentration on membrane uniformity and support filling. Support filling is evaluated by sPPS optical extinction in Fourier transform infrared spectroscopy.

In some embodiments, ionic conductivity of the prepared membranes is evaluated with AC-impedance spectroscopy as a function of temperature and humidity in a Scribner fuel cell test stand with a membrane conductivity attachment. Temperature is varied from 30° C. to 120° C. and relative humidity can be varied from 95% to anhydrous conditions.

In some embodiments, mechanical properties of the prepared membranes are evaluated under dry and water soaked conditions at ambient temperatures. Briefly, the samples are measured in an Instron micro-tensile tester to obtain the stress strain curve, and elongation at break per ASTM1708 sample preparation and ASTM D882 measurement standards. Thickness is measured using a standard caliper capable of measuring thicknesses down to micrometer range.

In some embodiments, H₂ crossover is monitored using the limiting current density method per DOE guidelines. H₂ is flowed at the anode and N₂ at the cathode, and cathode potential is swept from the rest potential to 900 mV with respect to the anode while measuring anodic current.

In some embodiments, membranes are dried at 80° C. for 12 hours before collecting initial size, thickness, and weight measurements. Membranes are then soaked in 30° C. water for 24 hours and remeasured for size, thickness, and weight to determine swelling in water. Following swelling test, membranes are submerged in 100° C. water for 200 hours before drying at 80° C. for 12 hours and weighed to identify any weight change.

In some embodiments, hydrocarbon+Ce(ATMP) complex membranes are tested for fuel cell operation. In some embodiments, sPPS+Ce(ATMP) complex membranes are loaded in a fuel cell test stand with gas diffusion electrodes having a nominal loading of 0.2 mg Pt/cm². The membrane electrode assemblies (MEA) are then tested for fuel cell operation by measuring cell voltage versus current density as a function of temperature and degree of humidification. Then, the catalyst-coated membrane (CCM) are also subjected to accelerated degradation test by holding CCM at open circuit voltage per DOE guidelines.

In some embodiments, AST is used to assess membrane durability. This stress test, which involves RH cycling under wet and dry conditions along with monitoring of fuel cell open circuit potential and hydrogen crossover is used to quantify membrane durability. Membrane degradation is evaluated using hydrogen crossover, shorting resistance, hydrogen-air polarization curve measurements, and fluoride emissions rates. Post mortem analysis of membranes and MEAs is carried out to identify microstructural changes such as cerium migration, membrane thinning, and pin-hole formation.

In some embodiments, CCMs comprising a core sPPS+Ce(ATMP) complex membrane and catalyst coating (sPPS+Ce(ATMP) complex, Pt, carbon black) are fabricated with a nominal loading of 0.5 mg Pt/cm² by directly coating the catalyst layer onto the membrane. Briefly, catalyst material is deposited by spray-coating using a Sonotek ExactaCoat system with an ultrasonic nozzle before an annealing process to crosslink the hydrocarbon polymer. Morphology is characterized by top down and cross-section electron microscopy to determine microstructure with special attention on the interface with the underlying membrane. General homogeneity is monitored by light microscopy. Viscosity, layer thickness, and homogeneity is tuned by deposition temperature and solution concentration.

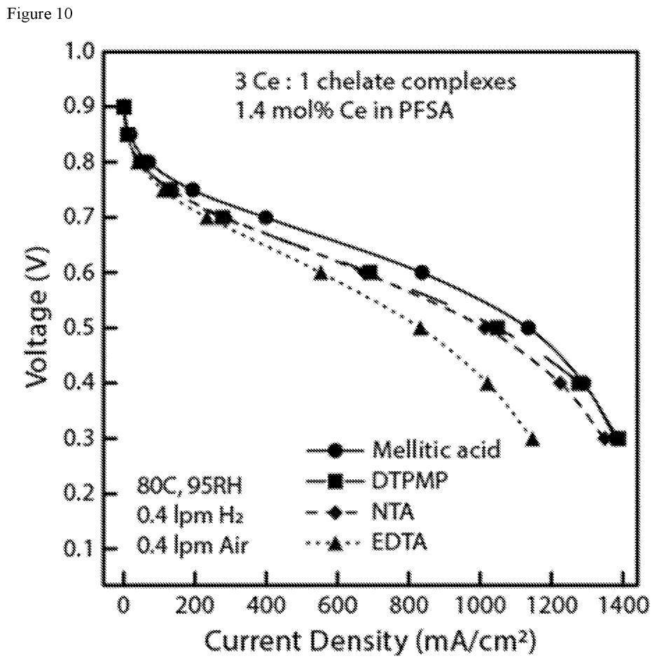

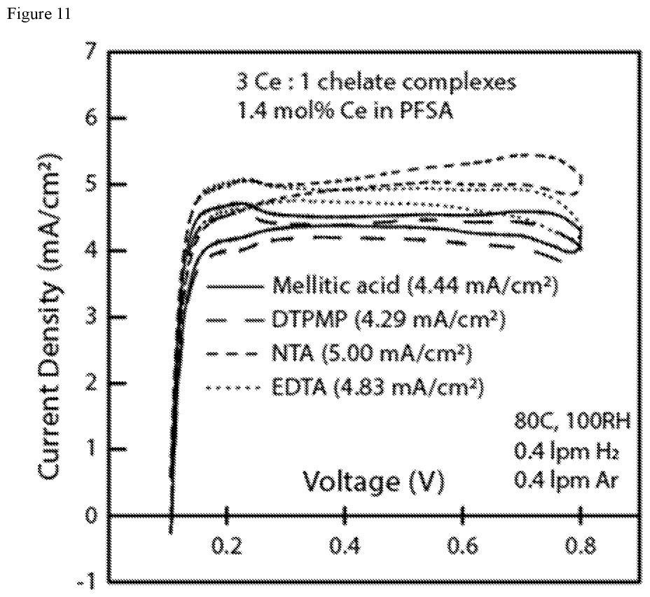

In some embodiments, the present disclosure describes preparation of Ce complexes with the following multidentate ligands: diethylenetriaminepentakis(methylene phosphonic acid) (DTPMP), nitrilotriacetic acid (NTA), ethylenediaminetetraacetic acid (EDTA), and mellitic acid. The complexes were prepared with a 3:1 Ce:ligand ratio. The synthesized complexes were combined with PFSA in a suspension, and the suspension was applied to a porous ePTFE layer to form a composite polyelectrolyte membrane. The resulting supported polyelectrolyte membranes comprising PFSA ionomer (D2020) and 1.4 mol % Ce complex in a ePTFE matrix function as effective PEM fuel cell membranes as demonstrated by the generation of a polarization curve under H₂ and air conditions (FIG. 10). Further, the membranes are effective PEM fuel cell membranes as was demonstrated in H₂ crossover experiments, resulting in measurably low hydrogen crossover (FIG. 11). These data demonstrate that incorporation of Ce complexes with a variety of multidentate ligands in polyelectrolyte membranes does not result in increased hydrogen permeability.

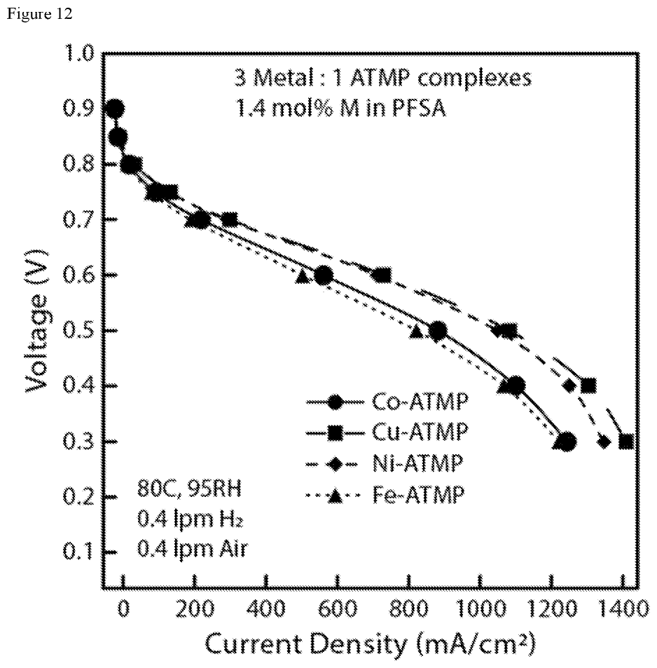

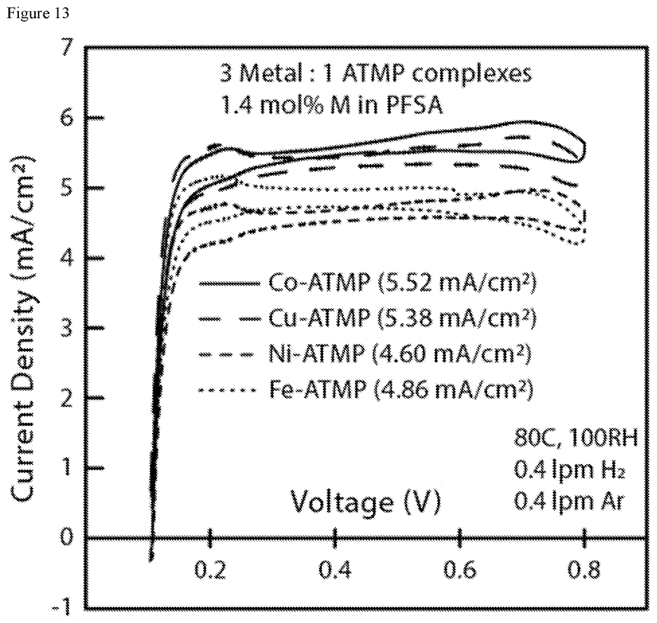

In some embodiments, the present disclosure describes preparation of complexes with ATMP as the ligand with a variety of metals (Co, Cu, Fe, Ni). The complexes were prepared with a 3:1 metal:ligand ratio. The synthesized complexes were combined with PFSA in a suspension, and the suspension was applied to a porous ePTFE layer to form a composite polyelectrolyte membrane. The resulting supported polyelectrolyte membranes comprising PFSA ionomer (D2020) and 1.4 mol % metal complex in a ePTFE matrix function as effective PEM fuel cell membranes as demonstrated by the generation of a polarization curve under H₂ and air conditions (FIG. 12). Further, the membranes are effective PEM fuel cell membranes as was demonstrated in H₂ crossover experiments, resulting in measurably low hydrogen crossover (FIG. 13). These data demonstrate that incorporation of complexes comprising ATMP as the ligand with a variety of metals in polyelectrolyte membranes does not result in increased hydrogen permeability.

### Definitions

Numeric ranges are inclusive of the numbers defining the range. For example, “x is an integer from 5 and 14” means that x can be 5, 6, 7, 8, 9, 10, 11, 12, 13, or 14. Measured and measureable values are understood to be approximate, taking into account significant digits and the error associated with the measurement. As used in this application, the terms “about” and “approximately” have their art-understood meanings; use of one vs the other does not necessarily imply different scope. Unless otherwise indicated, numerals used in this application, with or without a modifying term such as “about” or “approximately”, should be understood to encompass normal divergence and/or fluctuations as would be appreciated by one of ordinary skill in the relevant art. In certain embodiments, the term “approximately” or “about” refers to a range of values that fall within 10%, 9%, 8%, 7%, 6%, 5%, 4%, 3%, 2%, 1%, or less in either direction (greater than or less than) of a stated reference value unless otherwise stated or otherwise evident from the context (except where such number would exceed 100% of a possible value).

As used herein, the term “polyelectrolyte” refers to a polymer which under a particular set of conditions has a net positive or negative charge due to the presence of charged repeat units. In some embodiments, a polyelectrolyte is or comprises a polycation; in some embodiments, a polyelectrolyte is or comprises a polyanion. In some embodiments, a polyelectrolyte has a neutral charge under certain conditions, e.g., a particular range of pH values, but can become a polycation or a polyanion under different conditions. Polycations have a net positive charge and polyanions have a net negative charge. The net charge of a given polyelectrolyte may depend on the surrounding chemical conditions, e.g., on the pH.

As used herein, the term “degree of sulfonation” refers to the number of repeat units that have at least one sulfonic acid/sulfonate group. For example, 20% degree of sulfonation indicates a polymer that has 20 percent of its repeat units sulfonated, while 100% degree of sulfonation indicates every repeat unit in the polymer contains one sulfonic acid/sulfonate salt group. This may include polymers that contain multiple sulfonic acid/sulfonate groups per repeat unit (e.g., disulfonation, trisulfonation, tetrasulfonation, etc). In some embodiments, the sulfonated polymer can comprise on average 2 sulfonic acid groups per repeat unit, which corresponds to 200% degree of sulfonation. In some embodiments, the sulfonated polymer can comprise on average 2, 3, 4, or 5 sulfonic acid groups per repeat unit, which corresponds to 200%, 300%, 400%, or 500% degree of sulfonation, respectively. In some embodiments, the sulfonated polymer can comprise on average from 1.5 to 2.5 sulfonic acid groups per repeat unit, which corresponds to 150% to 250% degree of sulfonation.

The sulfonated polymers of the disclosure can also be characterized by the average number of sulfonic acid groups per repeat unit. For example, a sulfonated polyphenyl sulfone (sPPS) can comprise 1, 2, 3, 4, 5, 6, 7, or 8 sulfonic acid groups per repeat unit. For example, a repeat unit of sPPS can comprise 2 sulfonic acid groups:

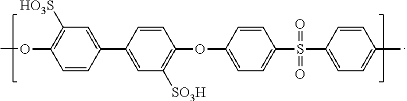

Alternatively, a repeat unit of sPPS can comprise 4 or 6 sulfonic acid groups:

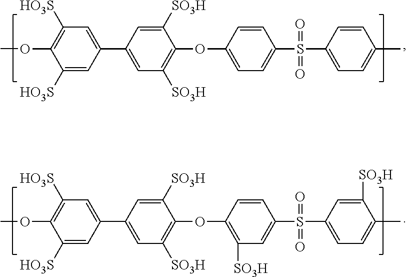

In a given polymer, some repeat units can have, for example, 1 sulfonic acid group, some repeat units can have 2 sulfonic acid groups, and some repeat units can have 3 or more sulfonic acid groups. Accordingly, the number of sulfonic acid groups per repeat unit that is measured in a bulk polymer by analyzing, for example, its 1H NMR spectrum or ion exchange capacity, corresponds to the average number of sulfonic groups across all the repeat units of the polymer.

As used herein, the term “polyphenyl sulfone” refers to a polymer comprising the following repeat unit:

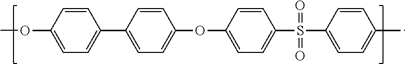

As used herein, the term “polyether ether ketone” refers to a polymer comprising the following repeat unit:

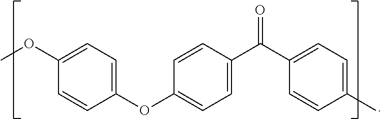

As used herein, the term “polybenzimidazole” refers to a polymer comprising the following repeat unit:

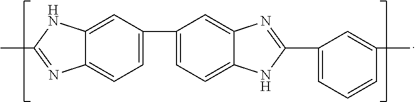

As used herein, the term “polyether sulfone” refers to a polymer comprising the following repeat unit:

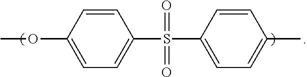

As used herein, the term “polyphenylene oxide” refers to a polymer comprising the following repeat unit:

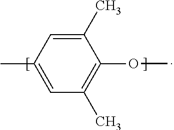

As used herein, the term “polyarylene ether ketone” refers to a polymer comprising one or more of the following repeat units:

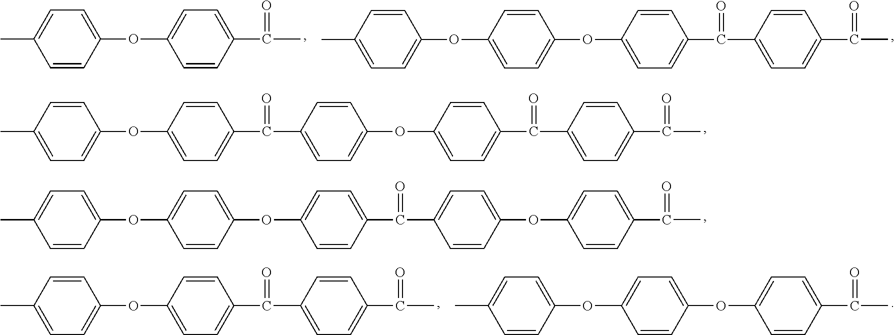

As used herein, the term “poly(sulfone)” refers to a polymer comprising the following repeat unit:

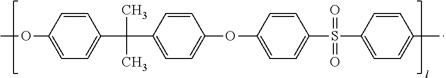

As used herein, the term “poly(sulfide sulfone)” refers to a polymer comprising the following repeat unit:

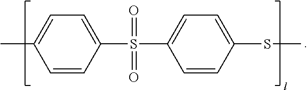

As used herein, the term “polyimide” refers to a polymer comprising the following repeat unit:

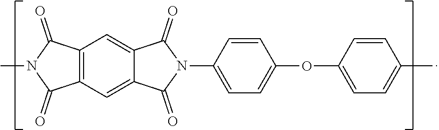

As used herein, the term “poly(etherimide)” refers to a polymer comprising the following repeat unit:

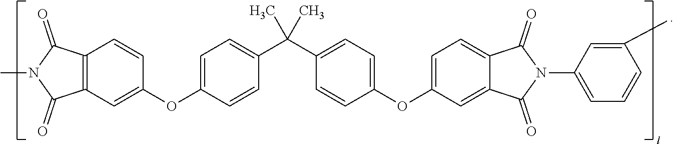

As used herein, the term “polyetherpyridine” refers to a polymer comprising the following repeat unit:

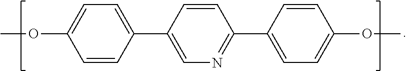

As used herein, the term “polyphosphazene” refers to a polymer comprising the following repeat unit:

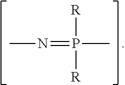

As used herein, the term “sulfo-phenylated polyphenylene” refers to a polymer comprising the following repeat unit:

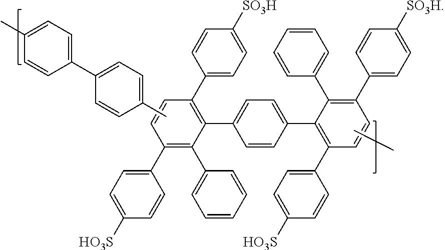

As used herein, the term “mellitic acid” refers to the following compound:

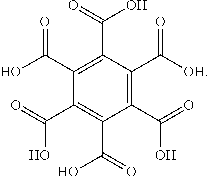 [SMILES: O=C(O)c1c(C(=O)O)c(C(=O)O)c(C(=O)O)c(C(=O)O)c1C(=O)O]

As used herein, the term “nitrilotriacetic acid” refers to the following compound:

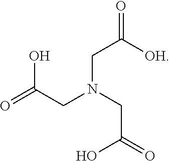 [SMILES: O=C(O)CN(CC(=O)O)CC(=O)O]

Any of the polymer repeat units described above can have one or more hydrogen atoms substituted with a —CN, —NO₂, —N₃, —OH, F, Cl, Br, I, oxo, —SO₂H, —SO₃H, —OR^{aa}, —NH(R^{aa}), —N(R^{aa})₂, —N(R^{aa})₃⁺X⁻, —SH, —SR^{aa}, —C(═O)R^{aa}, —CO₂H, —CHO, —CO₂R^{aa}, —OC(═O)R^{aa}, —OCO₂R^{aa}, —C(═O)N(R^{aa})₂, —OC(═O)N(R^{aa})₂, —NR^{aa}C(═O)R^{aa}, —NR^{aa}CO₂R^{aa}, —NR^{aa}C(═O)N(R^{aa})₂, —C(═NR^{aa})R^{aa}, —C(═O)NR^{aa}SO₂R^{aa}, —NR^{aa}SO₂R^{aa}, —SO₂N(R^{aa})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, C₁₋₁₂ alkyl, C₁₋₁₂ alkoxy, C₁₋₁₂ haloalkyl, C₃₋₁₂ cycloalkyl, 3-16 membered heterocyclyl, 5-12 membered heteroaryl, and C₆₋₁₂ aryl, wherein X is a counterion and each instance of R^{aa} is independently selected from H, —OH, C₁₋₁₀ alkyl, C₁₋₁₀ haloalkyl, C₃₋₁₂ cycloalkyl, 3-16 membered heterocyclyl, 5-12 membered heteroaryl, and C₆₋₁₂ aryl, or two R^{aa} groups are joined to form a 3-16 membered heterocyclyl.

As used herein, and “complex anion” is a negatively charged group associated with a positively charged group in order to maintain electronic neutrality. A complex anion may be monovalent (i.e., including one formal negative charge). A complex anion may also be multivalent (i.e., including more than one formal negative charge), such as divalent or trivalent. Exemplary complex anions includes halide ions (e.g., F⁻, Cl⁻, Br⁻, I⁻), NO₃⁻, ClO₄⁻, H₂PO₄⁻, HCO₃⁻, HSO₄⁻, sulfonate ions (e.g., methanesulfonate, trifluoromethanesulfonate, p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), carboxylate ions (e.g., formate, acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄⁻, B(C₆F₅)₄⁻, BPh₄⁻, Al(OC(CF₃)₃)₄⁻, and carborane anions (e.g., CB₁₁H₁₂⁻ or (HCB₁₁Me₅Br₆)⁻). Exemplary anionic counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes.

As used herein, the term “polyalcohol” refers to an alcohol comprising more than one hydroxyl group. Examples of polyalcohols include, but are not limited to, ethylene glycol, propylene glycol, 1,3-propanediol, 1,4-butanediol, glycerol, erythriol, xylitol, hydroquinone, catechol, resorcinol, and phloroglucinol.

As used herein, the term “perfluorosulfonic acid” or “PFSA” refers to a polymer represented by the following structural formula:

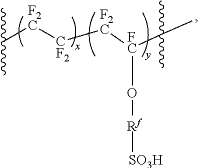

where R^{f} represents a perfluoroalkylene or perfluorooxyalkylene group, and x and y the relative proportion of perfluoro monomer and sulfonated monomer respectively. As used herein, the terms “perfluoroalkylene” or “perfluorooxyalkylene” refer to an alkylene or an oxyalkylene groups in which all hydrogen atoms have been substituted with fluorines. A class of PFSAs is represented by the structural formula (I):

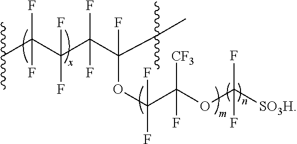

Such PFSAs are usually categorized according to their side-chain length. For example, Aquivion® (formerly Dow SSC) PFSAs are commonly classified as short-side-chain (SSC) PFSAs, while Nafion® is considered as a long-side-chain (LSC) PFSA. Examples of commercial PFSAs include the following:

| PFSA | m | n |
|---|---|---|
| Nafion ® | 1 | 2 |
| Aciplex ® | 0-3 | 2-5 |
| Flemion ® | 0 or 1 | 1-5 |
| 3M ™ | 0 | 4 |
| SSC | 0 | 2 |

As used herein, the term “crosslinking” refers to formation of a covalent or ionic bond between an polymer repeat unit and another repeat unit that is part of the same or different main chain, or between a polymer repeat unit and a crosslinking reagent.

As used herein, the term “crosslinked polymer” refers to a polymer in which two or more non-adjacent repeat units of the same or different main chains are connected via a crosslinking moiety. The term “crosslinked polymer” also refers to two or more different main chains connected via a plurality of crosslinking moieties.

As used herein, the term “crosslinking moiety” refers a polyvalent, for example, divalent or trivalent, moiety which forms a covalent bond with one or more non-adjacent repeat units of the same polymer main chain or with one or more repeat units of different main chains. A crosslinking moiety can comprise charged groups, for example, an ammonium group, a metal ion, a carboxylate group, or a sulfate group. In some embodiments, a crosslinking moiety is represented by one of the following structural formulas:

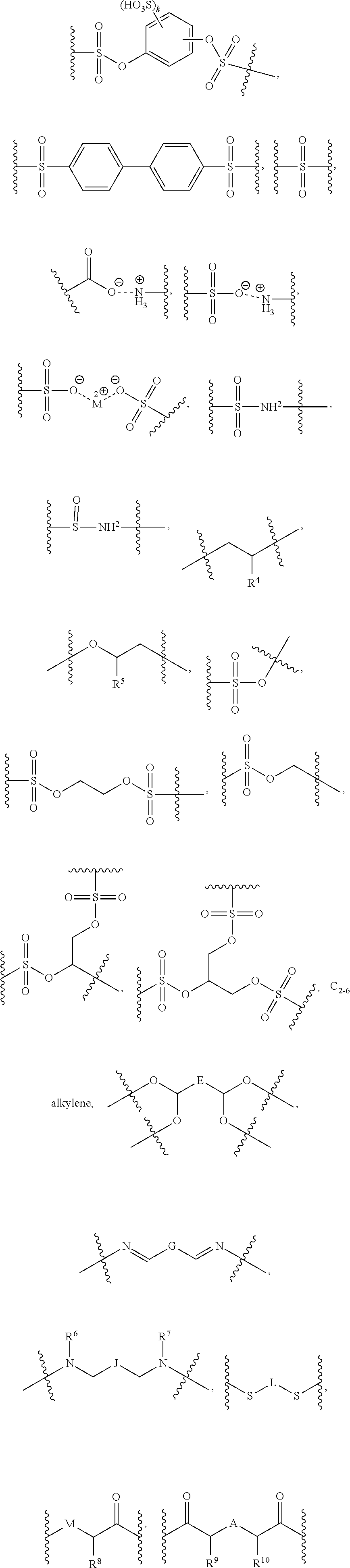

and, wherein: R¹ is H or —SO₃H; k is 0, 1, or 2; each of R², R³, R⁴, R⁵, R⁶, R⁷, R⁸, R⁹, and R¹⁰ is independently selected from H, C₁₋₁₂ alkyl, C₁₋₁₂ haloalkyl, C₆₋₁₄ aryl, and C₆₋₁₄ aryl(C₁₋₁₂ alkylene); each of A, E, G, J, L, and M is independently selected from a bond, C₁₋₁₂ alkylene, and C₆₋₁₄ arylene; each of R^{a} and R^{a*} is independently H or C₁₋₁₂ alkyl; M²⁺ is selected from Mg²⁺, Ca²⁺, Ba²⁺, and Al(X)²⁺, wherein X is halide, acetate, or nitrate; and the symbol “ [symbol] ” represents a point of attachment of the crosslinking moiety to a repeat unit of the first polymer.

As used herein, the term “crosslinking reaction” refers to a chemical reaction between functional groups attached to the repeat units of a polymer, or between functional groups attached to the repeat units of a polymer and a crosslinking reagent, resulting in formation of a covalent or electrostatic/ionic bonds between the polymer chains, or between the polymer chains and the crosslinking reagent. The polymers of the membranes disclosed herein can comprise one or more functional groups including, but not limited to, NH₂, —CN, —NCO, —N₃, —OH, F, Cl, Br, I, oxo, —SO₂H, —SO₃H, —OCO₂H, —OCO₂Cl, —SH, —CO₂H, —CHO, —CO₂Cl, C₂₋₁₂ alkenyl, and C₂₋₁₂ alkynyl.

As used herein, the term “conditions sufficient for the polymer and the crosslinking reagent to undergo a crosslinking reaction” refers to the external stimuli (e.g. heat, UV light, microwave irradiation, presence of a chemical initiator, such as a radical initiator) as well as time necessary in order to form the crosslinked polymer.

As used herein, the term “degree of crosslinking” in a polymer is defined as the fraction of the repeat units of a polymer that can undergo crosslinking, that have formed crosslinking moieties. In some embodiments, the degree of crosslinking is from about 5% to about 95%, from about 10% to about 80%, from about 20% to about 80%, from about 30% to about 70%, from about 40% to about 60%, from about 30% to about 50%, from about 20% to about 50%, from about 40% to about 70%, from about 20% to about 50%, or from about 10% to about 50%. In some embodiments, the degree of crosslinking is about 5%, about 10%, about 20%, about 30%, about 40%, about 50%, about 60%, about 70%, about 80%, or about 90%.

As used herein, the term “repeat unit” (also known as a monomer unit) refers to a chemical moiety which periodically repeats itself to produce the complete polymer chain (except for the end-groups) by linking the repeat units together successively. A polymer can contain one or more different repeat units.

As used herein, the “main chain” of a polymer, or the “backbone” of the polymer, is the series of bonded atoms that together create the continuous chain of the molecule. As used herein, a “side chain” of a polymer is the series of bonded atoms which are pendent from the main chain of a polymer.

As used herein, the term “alkyl” refers to a radical of a straight-chain or branched saturated hydrocarbon group having from 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, isobutyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

The term “haloalkyl” refers to a substituted alkyl group, wherein one or more of the hydrogen atoms are independently replaced by a halogen, e.g., fluoro, bromo, chloro, or iodo. In some embodiments, the haloalkyl moiety has 1 to 12 carbon atoms (“C₁₋₁₂ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “heterocyclyl” or “heterocyclic” refers to a radical of a 3- to 16-membered non-aromatic ring system having ring carbon atoms and 1 to 4 ring heteroatoms, wherein each heteroatom is independently selected from nitrogen, oxygen, and sulfur (“3-16 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl.

In some embodiments, a heterocyclyl group is a 4-10 membered non-aromatic ring system having ring carbon atoms and 1-4 ring heteroatoms, wherein each heteroatom is independently selected from nitrogen, oxygen, and sulfur (“4-10 membered heterocyclyl”). In some embodiments, a heterocyclyl group is a 4-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-12 membered aromatic ring system having ring carbon atoms and 1-4 ring heteroatoms provided in the aromatic ring system, wherein each heteroatom is independently selected from nitrogen, oxygen, and sulfur (“5-12 membered heteroaryl”). In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

The term “carbocyclyl” or “carbocyclic” refers to a radical of a non-aromatic cyclic hydrocarbon group having from 3 to 14 ring carbon atoms (“C₃₋₁₄ carbocyclyl”) and zero heteroatoms in the non-aromatic ring system. In some embodiments, “cycloalkyl” is a monocyclic, saturated carbocyclyl group having from 3 to 12 ring carbon atoms (“C₃₋₁₂ cycloalkyl”). In some embodiments, a cycloalkyl group has 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₆). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl.

The term “alkoxy” refers to an alkyl group, as defined herein, appended to the parent molecular moiety through an oxygen atom. In some embodiments, the alkoxy moiety has 1 to 12 carbon atoms (“C₁₋₁₂ alkoxy”). In some embodiments, the alkoxy moiety has 1 to 6 carbon atoms (“C₁₋₆ alkoxy”). In some embodiments, the alkoxy moiety has 1 to 4 carbon atoms (“C₁₋₄ alkoxy”). In some embodiments, the alkoxy moiety has 1 to 3 carbon atoms (“C₁₋₃ alkoxy”). In some embodiments, the alkoxy moiety has 1 to 2 carbon atoms (“C₁₋₂ alkoxy”). Representative examples of alkoxy include, but are not limited to, methoxy, ethoxy, propoxy, 2-propoxy, butoxy and tert-butoxy.

The term “sulfonic acid group” refers to the following group: —S(O)₂OH.

The term “sulfonate” refers to a salt or ester of sulfonic acid, —S(O)₂OR, where R represents a cation, such as a metal or ammonium cation, or an aliphatic or aromatic substituent. Examples of sulfonates include salts such as lithium sulfonate, sodium sulfonate, potassium sulfonate, or ammonium sulfonate. In some embodiments, the term “sulfonate” refers to an ester of sulfonic acid, for example, an optionally substituted C₁₋₁₂ alkyl sulfonate or an optionally substituted C₆₋₁₂ aryl sulfonate. In some embodiments, R is a multivalent (e.g., bivalent or trivalent) radical forming a covalent or ionic bond with one or more sulfonic acid groups attached to the same or different sulfonated polymer chain, thus forming a crosslinking moiety together with the two or more —S(O)₂O— groups to which it is attached.

The term “sulfonamide” refers to an amide of sulfonic acid, —S(O)₂NRR′, where R and R′ is each a hydrogen or an optionally substituted aliphatic or aromatic substituent, such as optionally substituted C₁₋₁₂ alkyl or an optionally substituted C₆₋₁₂ aryl. In some embodiments, R and/or R′ is each a multivalent (e.g., bivalent or trivalent) radical forming a covalent or ionic bond with one or more sulfonic acid groups attached to the same or different sulfonated polymer chain, thus forming a crosslinking moiety together with the two or more —S(O)₂O— groups to which it is attached.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, and arylene is the divalent moiety of aryl.

The term “substituted” refers to moieties having substituents replacing a hydrogen on one or more carbons of the backbone. It can be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxy, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It can be understood by those skilled in the art that substituents can themselves be substituted, if appropriate. Unless specifically stated as “unsubstituted,” references to chemical moieties herein are understood to include substituted variants. For example, reference to an “aryl” group or moiety implicitly includes both substituted and unsubstituted variants.

Exemplary carbon atom substituents include, but are not limited to, halogen, —CN, —NO₂, —N₃, —OH, F, Cl, Br, I, oxo, —SO₂H, —SO₃H, —OR^{aa}, —NH(R^{aa})₂, —N(R^{aa})₂, —N(R^{aa})₃⁺X⁻, —SH, —SR^{aa}, —C(═O)R^{aa}, —CO₂H, —CHO, —CO₂R^{aa}, —OC(═O)R^{aa}, —OCO₂R^{aa}, —C(═O)N(R^{aa})₂, —OC(═O)N(R^{aa})₂, —NR^{aa}C(═O)R^{aa}, —NR^{aa}CO₂R^{aa}, —NR^{aa}C(═O)N(R^{aa})₂, —C(═NR^{aa})R^{aa}, —C(═O)NR^{aa}SO₂R^{aa}, —NR^{aa}SO₂R^{aa}, —SO₂N(R^{aa})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, C₁₋₁₂ alkyl, C₁₋₁₂ haloalkyl, 3-16 membered heterocyclyl, and C₆₋₁₂ aryl, wherein X is a counterion and each instance of R^{aa} is, independently, selected from H, —OH, C₁₋₁₀ alkyl, C₁₋₁₀ haloalkyl, C₃₋₁₂ cycloalkyl, 5-16 membered heterocyclyl, and C₆₋₁₂ aryl, or two R^{aa} groups are joined to form a 3-16 membered heterocyclyl.

In a first embodiment the present disclosure relates to a polyelectrolyte membrane, comprising: a polyelectrolyte and a metal complex, wherein: the metal complex comprises a metal cation and a ligand; and the ligand comprises three or more functional groups, wherein each functional group is independently selected from phosphonic acid, sulfonic acid, and carboxylic acid, or an anion thereof.

In a first aspect of the first embodiment, the metal cation is selected from cations of Ce, Sc, Y, Ti, Zr, Hf, V, Nb, Ta, Cr, Mo, W, Mn, Fe, Co, Ni, Sm, Gd, and Th. For example, the metal cation is selected from the cations of Ce, Mn, and Zr. In some embodiments, the metal cation is selected from the cations of Ce, Cu, Fe, Co, and Ni. For example, the metal cation is a Ce cation. In some embodiments, the Ce cation is Ce⁴⁺. Alternatively, the Ce cation is Ce³⁺.

In a second aspect of the first embodiment, the ligand comprises three, four, five or six functional groups. For example, the ligand comprises three functional groups. For example, the ligand comprises four functional groups. For example, the ligand comprises five functional groups. For example, the ligand comprises six functional groups. The remainder of features and example features of the second aspect is as described above with respect to the first aspect of the first embodiment.

In a third aspect of the first embodiment, the ligand is selected from aminotris(methylene phosphonic acid) (ATMP), diethylenetriaminepentakis(methylene phosphonic acid) (DTPMP), ethylenediamine tetra(methylene phosphonic acid) (EDTMP), hexamethylenediamine tetra(methylene phosphonic acid) (HDTMP), bis(hexamethylenetriamine penta(methylene phosphonic acid) (BHMTMP), benzene trisulfonic acid, naphthalene trisulfonic acid, pyrenetetrasulfonic acid, triphenylphosphine-3,3′,3″-trisulfonic acid, nitrilotriacetic acid (NTA), citric acid, ethylenediaminetetraacetic acid (EDTA), benzenetricarboxylic acid, benzenetetracarboxylic acid, benzenepentacarboxylic acid, benzene-1,3,5-triacetic acid, mellitic acid, N,N-Bis(phosphonomethyl)glycine, 2,2′-((phosphonomethyl)azanedi-yl)diacetic acid, ethylene glycol-bis(2-aminoethylether)-N,N,N′,N′-tetraacetic acid, 1,2-bis(2-aminophenoxy)ethane-N,N,N′,N′-tetraacetic acid, ethylenediamine-N,N′-disuccinic acid N-(2-hydroxyethyl)ethylenediamine-N,N′,N′-triacetic acid, 1,2-diaminopropane-N,N,N′,N′-tetraacetic acid, 1,2,3,4-butanetetracarboxylic acid, 1,3-diamino-2-hydroxypropane-N,N,N′,N′-tetraacetic acid, 1,6-diaminohexane-N,N,N′,N′-tetraacetic acid, 1,2-diaminocyclohexane-N,N,N′,N′-tetraacetic acid, and 3,3′-dimethoxybenzidine-N,N,N′,N′-tetraacetic acid, or is an anion thereof. In some embodiments, the ligand is selected from ATMP, DTPMP, NTA, EDTA, and mellitic acid, or is an anion thereof. For example, the ligand is ATMP or an anion thereof. The remainder of features and example features of the third aspect is as described above with respect to the first and second aspects of the first embodiment.

In a fourth aspect of the first embodiment, the metal complex comprises the metal cation and the ligand in a molar ratio from about 20:1 to about 1:10. For example, the metal complex comprises the metal cation and the ligand in a molar ratio from about 20:1 to about 1:5; from about 15:1 to about 1:1; from about 15:1 to about 2:1; from about 12:1 to about 3:1 from about 12:1 to about 2:1; from about 12:1 to about 1:1; from about 12:1 to about; from about 9:1 to about 3:1; ratio from about 9:1 to about 2:1; from about 9:1 to about 1:1; from about 6:1 to about 3:1; from about 6:1 to about 2:1; or from about 6:1 to about 1:1. For example, the metal complex comprises the metal cation and the ligand in a molar ratio about 20:1; about 15:1; about 12:1; about 10:1; about 9:1; about 8:1; about 7:1; about 6:1; about 5:1; about 4:1; about 3:1; about 2:1; or about 1:1. In some embodiments, the metal complex comprises the metal cation and the ligand in a molar ratio about 6:1. In some embodiments, the metal complex comprises the metal cation and the ligand in a molar ratio about 3:1. The remainder of features and example features of the fourth aspect is as described above with respect to the first through the third aspects of the first embodiment.

In a fifth aspect of the first embodiment, the metal complex further comprises a complex anion. For example, the complex anion is selected from NO₃⁻, Cl⁻, F⁻, BF₄⁻, SO₄²⁻, HSO₄⁻, [(NH₄)₂(NO₃)₆]²⁻, CO₃²⁻, HCO₃⁻, CH₃CO₂⁻ and HCO₂⁻. In some embodiments, the complex anion is NO₃⁻ or Cl⁻. For example, the complex anion is NO₃⁻. Alternatively, the complex anion is Cl⁻. The remainder of features and example features of the fifth aspect is as described above with respect to the first through the fourth aspects of the first embodiment.

In a sixth aspect of the first embodiment, the polyelectrolyte and the metal complex form an admixture. For example, the polyelectrolyte and the metal complex form a homogenous admixture. The remainder of features and example features of the sixth aspect is as described above with respect to the first through the fifth aspects of the first embodiment.

In an eighth aspect of the first embodiment, the polyelectrolyte membrane comprises from about 0.1 wt. % to about 10 wt. % of the metal cation. For example, the polyelectrolyte membrane comprises from about 0.5 wt. % to about 5 wt. %, such as from about 0.7 wt. % to about 2 wt. %, or from about 0.8 wt. % to about 1.2 wt. % of the metal cation. For example, the polyelectrolyte membrane comprises about 0.1 wt. %, about 0.2 wt. %, about 0.3 wt. %, about 0.4 wt. %, about 0.6 wt. %, about 0.7 wt. %, about 0.8 wt. %, about 0.9 wt. %, about 1.0 wt. %, about 2 wt. %, about 3 wt. %, about 4 wt. %, about 5 wt. %, about 6 wt. %, about 7 wt. %, about 8 wt. %, about 9 wt. %, or about 10 wt. % of the metal cation. For example, the polyelectrolyte membrane comprises about 1 wt. % of the metal cation. The remainder of features and example features of the eighth aspect is as described above with respect to the first through the sixth aspects of the first embodiment.

In a ninth aspect of the first embodiment, the polyelectrolyte comprises a plurality of sulfonic acid moieties, and the polyelectrolyte membrane comprises from about 0.001 to about 0.1 metal cations per sulfonic acid group. For example, the polyelectrolyte membrane comprises from about 0.005 to about 0.05, from about 0.007 to about 0.02, or from about 0.008 to about 0.018 metal cations per sulfonic acid group. For example, the polyelectrolyte membrane comprises about 0.001, about 0.002, about 0.003, about 0.004, about 0.005, about 0.006, about 0.007, about 0.008, about 0.009, about 0.01, about 0.02, about 0.03, about 0.04, about 0.05, about 0.06, about 0.07, about 0.08, about 0.09, or about 0.1 metal cations per sulfonic acid group. In some embodiments, the polyelectrolyte membrane comprises about 0.014 metal cations per sulfonic acid group. The remainder of features and example features of the ninth aspect is as described above with respect to the first through the eighth aspects of the first embodiment.

In a tenth aspect of the first embodiment, the polyelectrolyte is sulfonated. In some embodiments the sulfonated polyelectrolyte comprises a plurality of sulfonic acid groups and/or a plurality of sulfonates. For example, the sulfonated polyelectrolyte comprises a plurality of sulfonic acid groups. The remainder of features and example features of the tenth aspect is as described above with respect to the first through the ninth aspects of the first embodiment.

In an eleventh aspect of the first embodiment, the polyelectrolyte is selected from sulfonated polyphenyl sulfone (sPPS), sulfonated polyether ether ketone (sPEEK), sulfonated polyphosphazene (sPOP), sulfonated polybenzimidazole (sPBI), sulfonated polyether sulfone (sPES), sulfonated polyphenylene oxide (sPPO), sulfonated polyarylene ether ketone (sPAEK), sulgonated polyphenyl sulfone, sulfonated poly(sulfone), sulfonated poly(sulfide sulfone), sulfonated polyimide (sPI), sulfonated poly(etherimide) (sPEI), sulfonated poly(amine), sulfo-phenylated polyphenylene, and sulfonated polyetherpyridine, or is a combination thereof. For example, the polyelectrolyte is sPPS. The remainder of features and example features of the eleventh aspect is as described above with respect to the first through the tenth aspects of the first embodiment.

In a twelfth aspect of the first embodiment, the polyelectrolyte is perfluorosulfonic acid (PFSA). In some embodiments, the PFSA is a polymer comprising a repeat unit represented by structural formula (I):

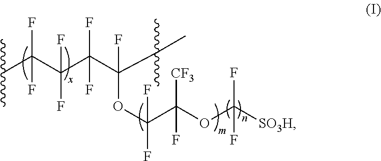

wherein x is an integer between 1 and 15, m is an integer between 0 and 2, n is an integer between 1 and 5, and the symbol [symbol] represents a point of attachment to a neighboring repeat unit. For example, the PFSA is a polymer comprising a repeat unit represented by structural formula (I), wherein x is an integer between 5 and 14, m is 1 or 2, and n is 2 or 3. The remainder of features and example features of the twelfth aspect is as described above with respect to the first through the eleventh aspects of the first embodiment.

In a thirteenth aspect of the first embodiment, the degree of sulfonation of the polyelectrolyte is from about 100% to about 400%. For example, the degree of sulfonation of the polyelectrolyte is from about 10% to about 100%, from about 20% to about 100%, from about 30% to about 100%, from about 40% to about 100%, from about 50% to about 100%, from about 60% to about 100%, from about 70% to about 100%, from about 80% to about 100%, from about 50% to about 200%, from about 80% to about 200%, from about 100% to about 200%, from about 100% to about 250%, from about 150% to about 200%, from about 100% to about 300%, from about 100% to about 350%, from about 100% to about 400%, from about 150% to about 250%, from about 150% to about 300%, from about 150% to about 350%, from about 150% to about 400%, from about 200% to about 300%, from about 200% to about 350%, from about 200% to about 400%, or from about 250% to about 350%. For example, the degree of sulfonation of the polyelectrolyte is about 20%, about 30%, about 40%, about 50%, about 60%, about 70%, about 80%, about 90%, about 100%, about 120%, about 140%, about 160%, about 180%, about 200%, about 220%, about 240%, about 260%, about 280%, about 300%, about 320%, about 340%, about 360%, about 380%, or about 400%. For example, the degree of sulfonation of the polyelectrolyte is from about 100% to about 300%. For example, the degree of sulfonation of the polyelectrolyte is about 200%. For example, the polyelectrolyte comprises on average from about 1 to about 3 sulfonic acid, sulfonate, and sulfonamide groups, combined, per repeat unit. For example, the polyelectrolyte comprises on average about 2 sulfonic acid, sulfonate, and sulfonamide groups, combined, per repeat unit. The remainder of features and example features of the thirteenth aspect is as described above with respect to the first through the twelfth aspects of the first embodiment.

In a fourteenth aspect of the first embodiment, the polyelectrolyte is crosslinked. For example, the polyelectrolyte comprises a crosslinking moiety represented by one of the following structural formulas:

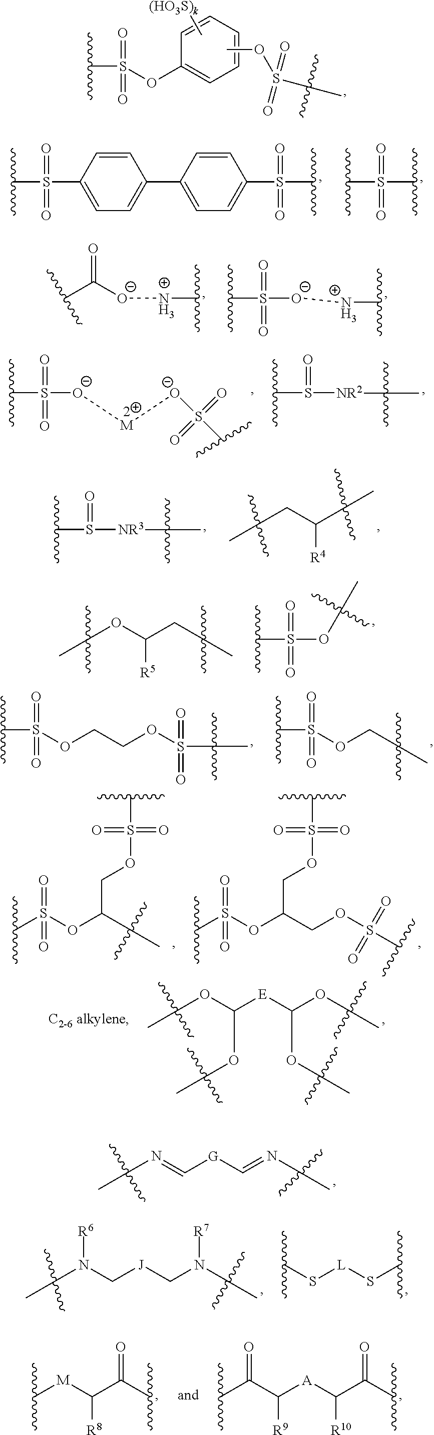

and wherein:
k is 0, 1, or 2;
each of R², R³, R⁴, R⁵, R⁶, R⁷, R⁸, R⁹, and R¹⁰ is independently selected from H, C₁₋₁₂ alkyl, C₁₋₁₂ haloalkyl, C₆₋₁₄ aryl, and C₆₋₁₄ aryl(C₁₋₁₂ alkylene);
each of A, E, G, J, L, and Mis independently selected from a bond, C₁₋₁₂ alkylene, and C₆₋₁₄ arylene;
each of R^{a} and R^{a*} is independently H or C₁₋₁₂ alkyl;
M²⁺ is selected from Mg²⁺, Ca²⁺, Ba²⁺, and Al(X)²⁺, wherein X is halide, acetate, or nitrate;
and the symbol “ [symbol] ” represents a point of attachment of the crosslinking moiety to a repeat unit of the polyelectrolyte. In some embodiments, the crosslinking moiety is represented by one of the following structural formulas:

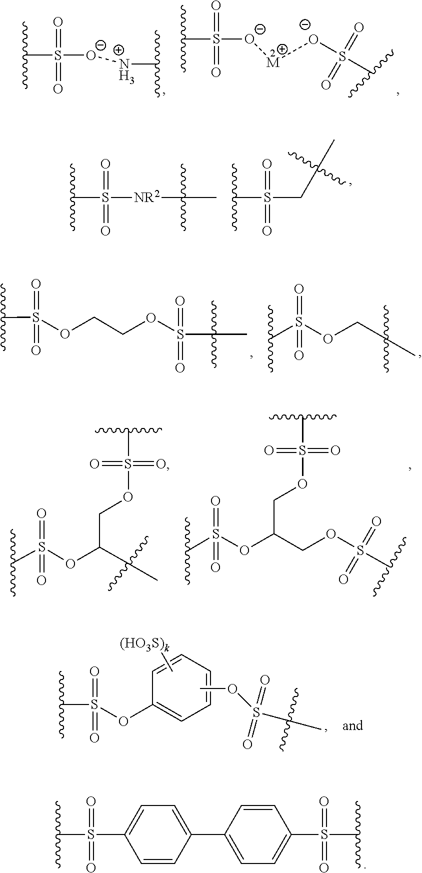

For example, the crosslinking moiety is represented by one of the following structural formulas:

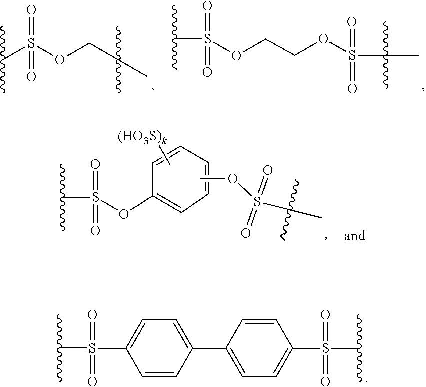

In some embodiments, the crosslinking moiety is represented by the following structural formula:

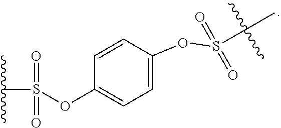 [SMILES: *S(=O)(=O)Oc1ccc(OS(*)(=O)=O)cc1]

The remainder of features and example features of the fourteenth aspect is as described above with respect to the first through the thirteenth aspects of the first embodiment.

In a fifteenth aspect of the first embodiment, the degree of crosslinking of the polyelectrolyte is from about 10% to about 95%. For example, the degree of crosslinking of the polyelectrolyte is from about 15% to about 90%, from about 20% to about 80%, from about 20% to about 70%, from about 20% to about 60%, from about 20% to about 50%, from about 20% to about 45%, from about 20% to about 40%, from about 30% to about 50%, from about 25% to about 30%, or from about 30% to about 35%. In some embodiments, the degree of crosslinking of the polyelectrolyte is from about 30% to about 50%. For example, the degree of crosslinking of the polyelectrolyte is about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%. For example, the degree of crosslinking of the polyelectrolyte about 70%. For example, the degree of crosslinking of the polyelectrolyte is about 40%. The remainder of features and example features of the fifteenth aspect is as described above with respect to the first through the fourteenth aspects of the first embodiment.

In a sixteenth aspect of the first embodiment, the metal cation is Ce cation; the ligand is selected from ATMP, DTPMP, NTA, EDTA, and mellitic acid, or is an anion thereof; and the polyelectrolyte is PFSA. For example, the metal cation is Ce³⁺; the ligand is selected from ATMP, DTPMP, NTA, EDTA, and mellitic acid, or is an anion thereof; and the polyelectrolyte is PFSA. For example, the metal cation is Ce⁴⁺; the ligand is selected from ATMP, DTPMP, NTA, EDTA, and mellitic acid, or is an anion thereof; and the polyelectrolyte is PFSA. The remainder of features and example features of the sixteenth aspect is as described above with respect to the first through the fifteenth aspects of the first embodiment.

In a seventeenth aspect of the first embodiment, the metal cation is selected from cations of Ce Cu, Fe, Co, and Ni; the ligand is ATMP; and the polyelectrolyte is PFSA. For example, the metal cation is a Ce cation; the ligand is ATMP; and the polyelectrolyte is PFSA. The remainder of features and example features of the seventeenth aspect is as described above with respect to the first through the sixteenth aspects of the first embodiment.

In an eighteenth aspect of the first embodiment, the metal cation is selected from the cations of Ce, Zr, and Mn; the ligand is ATMP; and the polyelectrolyte comprises sPPS. For example, the metal cation is Ce; the ligand is ATMP; and the polyelectrolyte comprises sPPS. For example, the metal cation is Ce; the ligand is ATMP; and the polyelectrolyte comprises crosslinked sPPS. The remainder of features and example features of the eighteenth aspect is as described above with respect to the first through the seventeenth aspects of the first embodiment.

In an eighteenth aspect of the first embodiment, the sPPS is crosslinked sPPS. For example, the crosslinked sPPS comprises a crosslinking moiety represented by the following structural formula:

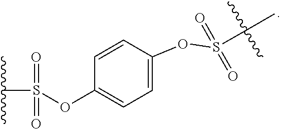 [SMILES: *S(=O)(=O)Oc1ccc(OS(*)(=O)=O)cc1]

The remainder of features and example features of the nineteenth aspect is as described above with respect to the first through the eighteenth aspects of the first embodiment.

In a twentieth aspect of the first embodiment, the metal cation is Ce cation; the ligand is ATMP; the metal complex further comprises NO³⁻; Ce cation and ATMP are present in a molar ratio of about 3:1; and the polymer is sPPS. For example, the metal cation is Ce cation; the ligand is ATMP; the metal complex further comprises NO³⁻; Ce cation and ATMP are present in a molar ratio of about 3:1; and the polymer is crosslinked sPPS. For example, the metal cation is Ce³⁺; the ligand is ATMP; the metal complex further comprises NO³⁻; Ce cation and ATMP are present in a molar ratio of about 3:1; and the polymer is crosslinked sPPS. For example, the metal cation is Ce⁴⁺; the ligand is ATMP; the metal complex further comprises NO³⁻; Ce cation and ATMP are present in a molar ratio of about 3:1; and the polymer is crosslinked sPPS. The remainder of features and example features of the twentieth aspect is as described above with respect to the first through the nineteenth aspects of the first embodiment.

In a twenty-first aspect of the first embodiment, the membrane is a free-standing membrane comprising the polyelectrolyte and the metal complex. In some embodiments, the membrane is a single layer membrane comprising the polyelectrolyte and the metal complex. For example, the membrane is a free-standing membrane consisting of the polyelectrolyte and the metal complex. For example, the membrane is a single layer membrane consisting of the polyelectrolyte and the metal complex. The remainder of features and example features of the twenty-first aspect is as described above with respect to the first through the twentieth aspects of the first embodiment.

In a twenty-second aspect of the first embodiment, the polyelectrolyte membrane is from about 2 μm to about 100 μm thick. For example, the polyelectrolyte membrane is about 2 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, or about 100 μm thick. The remainder of features and example features of the twenty-second aspect is as described above with respect to the first through the twenty-first aspects of the first embodiment.

In a twenty-third aspect of the first embodiment, the polyelectrolyte membrane further comprises a support polymer. The remainder of features and example features of the twenty-third aspect is as described above with respect to the first through the twenty-second aspects of the first embodiment.

In a twenty-fourth aspect of the first embodiment, the polyelectrolyte membrane comprises a porous matrix, wherein: the porous matrix comprises the support polymer; and the metal complex and the polyelectrolyte are dispersed in the porous matrix. For example, the metal complex and the polyelectrolyte are homogenously dispersed in the porous matrix. For example, the polyelectrolyte and the support polymer form an interpenetrating network. The remainder of features and example features of the twenty-fourth aspect is as described above with respect to the first through the twenty-third aspects of the first embodiment.

In a twenty-fifth aspect of the first embodiment, the support polymer is polytetrafluoroethylene (PTFE). For example, the PTFE is expanded PTFE. The remainder of features and example features of the twenty-fifth aspect is as described above with respect to the first through the twenty-fourth aspects of the first embodiment.

In a twenty-sixth aspect of the first embodiment, the polyelectrolyte membrane is from about 0.5 μm to about 100 μm thick. For example, the polyelectrolyte membrane is about 0.6 μm, about 0.8 μm, about 1.0 μm, about 2.0 μm, about 3.0 μm, about 4.0 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, or about 100 μm thick. For example, the polyelectrolyte membrane is about 8 μm thick. The remainder of features and example features of the twenty-sixth aspect is as described above with respect to the first through the twenty-fifth aspects of the first embodiment.

In a second embodiment, the present disclosure relates to a method of making the polyelectrolyte membrane described herein with respect to the first embodiment and various aspects thereof, the method comprising (a) providing a casting surface and a suspension comprising a metal complex, a polyelectrolyte, and (i) a crosslinking reagent, and/or (ii) a crosslinking initiator; (b) depositing the suspension on the casting surface, thereby providing a membrane layer; and (c) exposing the membrane layer to conditions sufficient for (i) the polyelectrolyte and the crosslinking reagent to undergo a crosslinking reaction, or (ii) the crosslinking initiator to initiate the crosslinking of the of the polyelectrolyte, thereby providing the polyelectrolyte membrane.

In a first aspect of the second embodiment, the suspension comprises from about 0.01 wt. % to about 10 wt. % of the metal complex. In some embodiments, the suspension comprises from about 0.1 wt. % to about 10 wt. % of the metal complex. For example, 0.05 wt. %, about 0.1 wt. %, about 0.15 wt. %, about 0.2 wt. %, about 0.25 wt. %, about 0.3 wt. %, about 0.35 wt. %, about 0.4 wt. %, about 0.45 wt. %, about 0.5 wt. % of the metal complex.

In a second aspect of the second embodiment, the suspension comprises from about 2 wt. % to about 50 wt. % of the polyelectrolyte. For example, the suspension comprises about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 35 wt. %, about 40 wt. %, about 45 wt. %, or about 20 wt. % of the polyelectrolyte. In some embodiments, the suspension comprises about 10 wt. % of the polyelectrolyte. The remainder of features and example features of the second aspect is as described above with respect to the first aspect of the second embodiment.

In a third aspect of the second embodiment, the polyelectrolyte comprises a crosslinkable group. For example, the crosslinkable group is selected from OH, NH₂, NH, SH, C(O)OH, C(O)Cl, C(O)Br, NHNH₂, N₃, S(O)₂OH, S(O)₂Cl, —NCO,

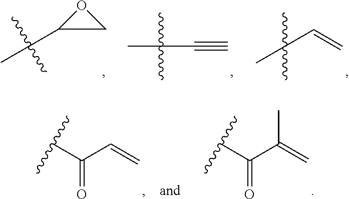

For example, the crosslinkable group is selected from OH, NH₂, SH, C(O)OH, C(O)Cl, C(O)Br, NHNH₂, N₃, S(O)₂OH, S(O)₂Cl, —NCO,

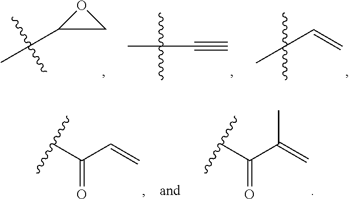

For example, the crosslinkable group is

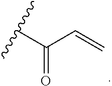 [SMILES: *C(=O)C=C]

For example, the crosslinkable group is NH. For example, the crosslinkable group is S(O)₂OH. The remainder of features and example features of the third aspect is as described above with respect to the first through the second aspects of the second embodiment.

In a fourth aspect of the second embodiment, the suspension comprises the crosslinking initiator. For example, the crosslinking initiator is selected from 2,2-dimethoxy-2-phenylacetophenone (DMPA), azobisisobutyronitrile (AIBN), and benzoyl peroxide (BPO). The remainder of features and example features of the fifth aspect is as described above with respect to the first through the fourth aspects of the second embodiment.

In a sixth aspect of the second embodiment, the conditions sufficient for the crosslinking initiator to initiate the crosslinking of the polyelectrolyte comprise visible light irradiation, UV light irradiation, application of heat, microwave irradiation, application of ultrasound, or gamma-ray irradiation. The remainder of features and example features of the sixth aspect is as described above with respect to the first through the fifth aspects of the second embodiment.

In a seventh aspect of the second embodiment, the suspension comprises from about 0.5 wt. % to about 50 wt. % of the crosslinking initiator. For example, the suspension comprises from about 5 wt. % to about 15 wt. % of the crosslinking initiator. For example, the suspension comprises about 0.2 wt. %, about 0.3 wt. %, about 0.4 wt. %, about 0.6 wt. %, about 0.7 wt. %, about 0.8 wt. %, about 0.9 wt. %, about 1.0 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, or about 20 wt. % of the crosslinking initiator. The remainder of features and example features of the seventh aspect is as described above with respect to the first through the sixth aspects of the second embodiment.

In an eighth aspect of the second embodiment, the suspension comprises the crosslinking reagent. For example, the crosslinking reagent is selected from a polyalcohol, an aldehyde, an amine, an epoxide, a thiol, or a compound comprising a terminal alkene or alkyne. For example, the crosslinking reagent is selected from glycerol, ethylene glycol, hydroquinone, 2,5-dihydroxybenzenesulfonic acid, 2,5-dihydroxybenzene-1,4-disulfonic acid, biphenyl, tetraglycidyl bis(p-aminophenyl) methane, phenylene diamine, 4,4′-thiobisbenzenethiol, and tetrafluoro styrene. For example, the crosslinking reagent is selected from glycerol, ethylene glycol, tetraglycidyl bis(p-aminophenyl) methane, phenylene diamine, 4,4′-thiobisbenzenethiol, glutaraldehyde, styrene, and tetrafluoro styrene. For example, the crosslinking reagent is a polyalcohol, such as glycerol or ethylene glycol. For example, the crosslinking reagent is hydroquinone or 2,5-dihydroxybenzenesulfonic acid. The remainder of features and example features of the eighth aspect is as described above with respect to the first through the seventh aspects of the second embodiment.

In a ninth aspect of the second embodiment, the conditions sufficient for the polyelectrolyte and the crosslinking reagent to undergo a crosslinking reaction with the polyelectrolyte comprise visible light irradiation, UV light irradiation, application of heat, microwave irradiation, application of ultrasound, or gamma-ray irradiation. The remainder of features and example features of the ninth aspect is as described above with respect to the first through the eighth aspects of the second embodiment.

In a tenth aspect of the second embodiment, the suspension further comprises a solvent. In some embodiments, the solvent is selected from dimethylformamide, tetrahydrofuran, N-methylformamide, formamide, acetonitrile, dimethylacetamide, propylene carbonate, ethylene carbonate, N-methylpyrrolidone, dimethylsulfoxide, or a combination thereof. The remainder of features and example features of the tenth aspect is as described above with respect to the first through the ninth aspects of the second embodiment.

In a third embodiment, the present disclosure relates to a method of making the polyelectrolyte membrane described herein with respect to the first embodiment and various aspects thereof, the method comprising (a) providing a porous matrix and a suspension comprising a metal complex and a polyelectrolyte; (b) contacting the porous matrix with the suspension, thereby providing an impregnated porous matrix; and (c) drying the impregnated porous matrix, thereby providing the polyelectrolyte membrane. In some embodiments, the method comprises repeating steps (b) and (c) one to five times, for example, one, two, three, four, or five times.

In a first aspect of the third embodiment, the suspension comprises from about 0.01 wt. % to about 10 wt. % of the metal complex. In some embodiments, the suspension comprises from about 0.1 wt. % to about 10 wt. % of the metal complex. For example, 0.05 wt. %, about 0.1 wt. %, about 0.15 wt. %, about 0.2 wt. %, about 0.25 wt. %, about 0.3 wt. %, about 0.35 wt. %, about 0.4 wt. %, about 0.45 wt. %, about 0.5 wt. % of the metal complex.

In a second aspect of the second embodiment, the suspension comprises from about 2 wt. % to about 50 wt. % of the polyelectrolyte. For example, the suspension comprises about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 35 wt. %, about 40 wt. %, about 45 wt. %, or about 20 wt. % of the polyelectrolyte. In some embodiments, the suspension comprises about 10 wt. % of the polyelectrolyte. The remainder of features and example features of the second aspect is as described above with respect to the first aspect of the third embodiment.

In a third aspect of the third embodiment, the polyelectrolyte comprises a crosslinkable group. For example, the crosslinkable group is selected from OH, NH₂, NH, SH, C(O)OH, C(O)Cl, C(O)Br, NHNH₂, N₃, S(O)₂OH, S(O)₂Cl, —NCO,

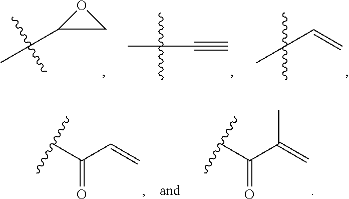

For example, the crosslinkable group is selected from OH, NH₂, SH, C(O)OH, C(O)Cl, C(O)Br, NHNH₂, N₃, S(O)₂OH, S(O)₂Cl, —NCO,

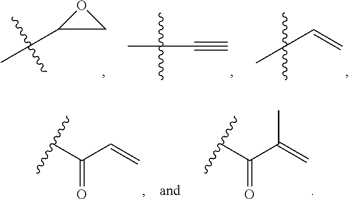

For example, the crosslinkable group is

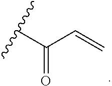 [SMILES: *C(=O)C=C]

For example, the crosslinkable group is NH. For example, the crosslinkable group is S(O)₂OH. The remainder of features and example features of the third aspect is as described above with respect to the first through the second aspects of the third embodiment.

In a fourth aspect of the third embodiment, the suspension further comprises a crosslinking initiator. In some embodiments, the crosslinking initiator is selected from 2,2-dimethoxy-2-phenylacetophenone (DMPA), azobisisobutyronitrile (AIBN), and benzoyl peroxide (BPO). The remainder of features and example features of the fifth aspect is as described above with respect to the first through the fourth aspects of the second embodiment.

In a sixth aspect of the third embodiment, the method further comprises a step of crosslinking the polyelectrolyte under conditions sufficient for the crosslinking initiator to initiate the crosslinking of the first polymer. For example, the conditions sufficient for the crosslinking initiator to initiate the crosslinking of the polyelectrolyte comprise visible light irradiation, UV light irradiation, application of heat, microwave irradiation, application of ultrasound, or gamma-ray irradiation. The remainder of features and example features of the sixth aspect is as described above with respect to the first through the fifth aspects of the third embodiment.

In a seventh aspect of the third embodiment, the suspension comprises from about 0.5 wt. % to about 50 wt. % of the crosslinking initiator. For example, the suspension comprises from about 5 wt. % to about 15 wt. % of the crosslinking initiator. For example, the suspension comprises about 0.2 wt. %, about 0.3 wt. %, about 0.4 wt. %, about 0.6 wt. %, about 0.7 wt. %, about 0.8 wt. %, about 0.9 wt. %, about 1.0 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, or about 20 wt. % of the crosslinking initiator. The remainder of features and example features of the seventh aspect is as described above with respect to the first through the sixth aspects of the third embodiment.

In an eighth aspect of the third embodiment, the suspension further comprises the crosslinking reagent. In some embodiments, the crosslinking reagent is selected from a polyalcohol, an aldehyde, an amine, an epoxide, a thiol, or a compound comprising a terminal alkene or alkyne. For example, the crosslinking reagent is selected from glycerol, ethylene glycol, hydroquinone, 2,5-dihydroxybenzenesulfonic acid, 2,5-dihydroxybenzene-1,4-disulfonic acid, biphenyl, tetraglycidyl bis(p-aminophenyl) methane, phenylene diamine, 4,4′-thiobisbenzenethiol, and tetrafluoro styrene. For example, the crosslinking reagent is selected from glycerol, ethylene glycol, tetraglycidyl bis(p-aminophenyl) methane, phenylene diamine, 4,4′-thiobisbenzenethiol, glutaraldehyde, styrene, and tetrafluoro styrene. For example, the crosslinking reagent is a polyalcohol, such as glycerol or ethylene glycol. For example, the crosslinking reagent is hydroquinone or 2,5-dihydroxybenzenesulfonic acid. The remainder of features and example features of the eighth aspect is as described above with respect to the first through the seventh aspects of the third embodiment.

In a ninth aspect of the third embodiment, the method further comprises a step of crosslinking the polyelectrolyte under conditions sufficient for the polyelectrolyte and the crosslinking reagent to undergo a crosslinking reaction. For example, the conditions sufficient for the polyelectrolyte and the crosslinking reagent to undergo a crosslinking reaction with the polyelectrolyte comprise visible light irradiation, UV light irradiation, application of heat, microwave irradiation, application of ultrasound, or gamma-ray irradiation. The remainder of features and example features of the ninth aspect is as described above with respect to the first through the eighth aspects of the third embodiment.

In a tenth aspect of the third embodiment, the suspension further comprises a solvent. In some embodiments, the solvent is selected from water, alcohol, dimethylformamide, tetrahydrofuran, N-methylformamide, formamide, acetonitrile, dimethylacetamide, propylene carbonate, ethylene carbonate, N-methylpyrrolidone, dimethylsulfoxide, or a combination thereof. For example, the solvent is a mixture of water and alcohol. For example, the solvent is a mixture of water and methanol, ethanol, or isopropanol. The remainder of features and example features of the tenth aspect is as described above with respect to the first through the ninth aspects of the third embodiment.

In an eleventh aspect of the third embodiment, contacting the porous matrix with the suspension comprises spray-coating, spin coating, drop-casting, zone casting, dip coating, blade coating, printing, vacuum filtration, slot die coating, curtain coating, or a combination thereof. For example, contacting the porous matrix with the suspension comprises dip coating and/or blade coating. The remainder of features and example features of the eleventh aspect is as described above with respect to the first through the tenth aspects of the third embodiment.

In a twelfth aspect of the third embodiment, drying the impregnated porous matrix comprises heating the impregnated porous matrix at a temperature from about 150° C. to about 200° C. for a period of time from about 1 minute to about 1 hour. For example, drying the impregnated porous matrix comprises heating the impregnated porous matrix at a temperature about 150° C., about 160° C., about 170° C., about 180° C., about 190° C., or about 200° C. For example, drying the impregnated porous matrix comprises heating the impregnated porous matrix at a temperature about 2 minutes, about 3 minutes, about 4 minutes, about 5 minutes, about 6 minutes, about 7 minutes, about 8 minutes, about 9 minutes, about 10 minutes, about 20 minutes, about 30 minutes, about 40 minutes, about 50 minutes, or about 60 minutes. The remainder of features and example features of the twelfth aspect is as described above with respect to the first through the eleventh aspects of the third embodiment.

In a fourth embodiment the present disclosure relates to a membrane electrode assembly (MEA), comprising a polyelectrolyte membrane described herein with respect to the first embodiment and various aspects thereof; a cathode; and an anode, wherein the polyelectrolyte membrane is disposed between the anode and the cathode.

In a fifth embodiment the present disclosure relates to a fuel cell, comprising one or more of the MEAs described herein with respect to the fourth embodiment and various aspects thereof and one or more gas flow bipolar plates.

### Exemplification

### Materials

PFSA dispersion D2020 (20 wt. %) was purchased from Fuel Cell Store (CAS #31175-20-9). Ethanol was purchased from Sigma-Aldrich (CAS #64-17-5). Isopropanol was purchased from Sigma-Aldrich (CAS #67-63-0). Hydrogen peroxide was purchased from Sigma-Aldrich (30%, CAS #7722-84-1). Hydrochloric acid (HCl) was purchased from Sigma-Aldrich (37%, CAS #7647-01-0). 8 μm thick ePTFE (expanded polytetrafluoroethylene) was purchased from UNM. Cerium (III) nitrate hexahydrate was purchased from Sigma-Aldrich (99.99%, CAS #16774-21-3). Cerium (IV) ammonium nitrate was purchased from Sigma-Aldrich (99.999%, CAS #10294-41-4). Iron (III) nitrate nonahydrate was purchased from Sigma-Aldrich (99.95%, CAS #7782-61-8). Iron (II) sulfate heptahydrate was purchased from Sigma-Aldrich (99%, CAS #7782-63-0). Nickel (II) chloride hexahydrate was purchased from Sigma-Aldrich (99.9%, CAS #7791-20-0). Copper (II) chloride dihydrate was purchased from Sigma-Aldrich (reagent, CAS #10125-13-0). Cobalt (II) chloride anhydrous was purchased from Sigma-Aldrich (synthesis grade, CAS #7646-79-9). ATMP (aminotrismethylenephosphonic acid) was purchased from Sigma-Aldrich (50%, CAS #6419-19-8). NTA (nitrilotriacetic acid) was purchased from Sigma-Aldrich (99%, CAS #139-13-9). DTPMP (Diethylenetriaminepentakis(methylphosphonic acid)) was purchased from Sigma-Aldrich (50%, CAS #15827-60-8). EDTA (Ethylenediaminetetraacetic acid) was purchased from Sigma-Aldrich (99%, CAS #60-00-4). Mellitic acid was purchased from Sigma-Aldrich (99%, CAS #517-60-2). PPS (Solvay Radel R-5000, MW=5000) was purchased from Solvay. Sulfuric acid (H₂SO₄) was purchased from Sigma-Aldrich (95-98%, CAS #7664-93-9). Hydroquinone was purchased from Sigma-Aldrich (>99%, CAS #123-31-9).

### Example 1. Sulfonation of PPS

PPS was sulfonated by reacting the polymer with H₂SO₄. PPS resin was ground into a powder using an industrial grinder. PPS was dissolved in concentrated H₂SO₄ at a concentration 25 mg/mL and stirred at 60° C. for 10 hrs. The sulfonated polymer was precipitated by adding the reaction mixture dropwise to H₂O at 0° C. The resulting precipitated polymer was centrifuged and isolated. The sulfonated PPS (sPPS) was redispersed in H₂O at room temperature and washed using dialysis until neutral pH was registered. The washed sPPS was dried on a hot plate to provide the final product. The yield of the reaction was determined by mass to be 91%. The resulting product had a titration determined ion exchange capacity (IEC) of 3.605 meq/g (2.0 sulfonic acids per repeat unit). The degree of sulfonation of sPPS can be tuned by adjusting the reaction time (1-8 hrs).

### Example 2. Determination of Membrane Durability Using Fenton Reagent Test

A membrane was allowed to dry in an oven under a nitrogen environment at 80° C. for 24 hours. The mass of the dried membrane was then recorded before placing the membrane in a 20 mL vial. DI water (89.267 mL) was added to the vial with the membrane. In a separate 20 mL vial, 10 mg of iron (II) sulfate heptahydrate was dissolved in 10 mL of DI water. Hydrogen peroxide (10 mL, 30%) was added to the vial with the membrane. Finally, 0.733 mL of the iron (II) sulfate heptahydrate solution was added to the vial with the membrane. The vial with the membrane was capped and placed in an aluminum bead bath at 80° C. for 48 hours. After the test, the membrane was rinsed 3 times with DI water before drying in an oven under a nitrogen environment at 80° C. for 24 hours. The mass of the final dried membrane was recorded.

### Example 3. Determination of Ce Content in Membranes

Cerium content after AST was determined using x-ray fluorescence (XRF) spectroscopy. Following AST, a coupon was stamped from the test area and the periphery from each membrane-electrode assembly. The periphery coupon was used to represent the pre-run cerium content while the test area represented the after case. Ce peaks from 4.658 keV to 5.821 keV were integrated. Sulfur peaks from 2.154 keV to 2.6 keV were integrated and used as an internal standard.

### Example 4. Preparation of Membrane Electrode Assembly

The polyelectrolyte membrane was used in a membrane electrode assembly (MEA) and tested in a single fuel cell with 5 cm² active area. For MEA preparation, a 3 inch×3 inch membrane was placed between two gas diffusion electrodes (GDEs) with 0.2 mg Pt/cm² (20% Pt on Vulcan carbon) on Sigracet 22 BB, each with an area of 5 cm². The GDEs had pre-deposited catalyst layer on the side of microporous layer and were implemented with the catalyst layer interfacing the membrane. 3 inch×3 inch PTFE gaskets with 5 cm² windows were placed on each side of the membrane to encompass the gas diffusion electrodes to prevent the leak of reactant gases. The gasket thickness was adjusted to allow for 80% compression of the GDEs when the MEA is tightened between two fuel cell end plates.

### Example 5. Testing of Polyelectrolyte Membrane in a Fuel Cell

The membrane performance was evaluated in a fuel cell via H₂ crossover measurement, fuel cell polarization curve, and accelerated stress test.

H₂ crossover was measured by performing cyclic voltammetry where cathode side electrode was scanned between 0.1 V and 0.8 V with a voltage scan rate of 2 mV/s at 80° C. and 100% RH with 0.4 lpm H₂ flow on the anode side and 0.4 lpm Ar flow on the cathode side with no backpressure.

Fuel cell polarization curve was measured by conducting constant voltage measurements from open circuit potential to 0.3 V back to open circuit potential at a 0.5 V increment between open circuit potential to 0.7 V and a 1 V increment between 0.7 V to 0.3 V at 80° C. at various RH values with 0.2 lpm H₂ flow on the anode side and 0.2 lpm air or 02 flow on the cathode side with a backpressure of 50 kPag.

Accelerated stress test was conducted by applying a relative humidity (RH) cycle where gases were switched between 0 and 100% RH at a 2 min interval while keeping the cell at open circuit. The cell was held at 90° C., with 0.1 lpm H₂ flow on the anode and 0.1 lpm air flow on the cathode with no backpressure. H₂ crossover, polarization curve, and electrochemical impedance were measured, and exhaust water was collected periodically during the accelerated stress test.

### Example 6. Casting Freestanding Membranes

Casting Freestanding sPPS Membranes with Ce(ATMP) or Ce(NO₃)₃

Solutions of 10 wt. % sPPS, 0.2 wt. % Ce(ATMP) or Ce(NO₃)₃, and 2.5 wt. % hydroquinone in water were added to a Kapton trough. The resulting mixture was allowed to dry overnight. The dried sPPS membranes were crosslinked by condensation reaction with the hydroquinone by heating to 210° C. for 2 hours under flowing nitrogen to achieve water stable membranes.

Casting Freestanding PFSA Membranes with Ce(ATMP)

A MSK-AFA-III—HB tape casting coater system was use to cast PFSA membranes. The coating solution consisted of PFSA dispersion D2020 (20 wt. %) and 0.29 wt. % Ce(ATMP) complex (3:1 Ce:ATMP) in a water:isopropanol mixed solvent such that there were 0.014 Ce atoms per sulfonic acid moiety in PFSA. The solution was sonicated for 30 min prior to use. The resulting PFSA ink was blade-coated directly onto glass. The PFSA ink cast was placed in a 180° C. oven for 5 minutes and allowed to cool to room temperature. The blade-coating was performed at 20 cm/min at room temperature.

### Example 7. Synthesis of Metal Complexes

### Ce(EDTA) Complex (3:1 Ce:EDTA)

In a 20 mL vial, 1.74 g cerium (III) nitrate hexahydrate was dissolved in 1.228 mL of 1M HCl in DI water under stirring. In a separate vial, 0.390 g of EDTA was dissolved in 1.229 mL of DI water. The Ce salt solution was added dropwise to the EDTA solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C.

### Ce(DTPMP) Complex (3:1 Ce:DTPMP)

In a 20 mL vial, 1.74 g cerium (III) nitrate hexahydrate was dissolved in 1.228 mL of 1M HCl in DI water under stirring. 1.229 mL of DTPMP solution (50 wt. % in water) was added to a separate vial. The Ce salt solution was added dropwise to the DTPMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Ce(Mellitic Acid) Complex (3:1 Ce:Mellitic Acid)

In a 20 mL vial, 1.74 g cerium (III) nitrate hexahydrate was dissolved in 1.228 mL of 1M HCl in DI water under stirring. In a separate vial, 0.456 g of mellitic acid was dissolved in 1.229 mL of DI water. The Ce salt solution was added dropwise to the mellitic acid solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Ce(NTA) Complex (3:1 Ce:NTA)

In a 20 mL vial, 1.74 g cerium (III) nitrate hexahydrate was dissolved in 1.228 mL of 1M HCl in DI water under stirring. In a separate vial, 0.255 g of NTA was dissolved in 1.229 mL of DI water. The Ce salt solution was added dropwise to the NTA solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Fe(ATMP) Complex (3:1 Fe:ATMP)

In a 20 mL vial, 1.114 g iron (III) nitrate nonahydrate was dissolved in 1.228 mL of 1M HCl in DI water under stirring. ATMP solution (50% in water, 1.229 mL) was added to a separate vial. The Fe salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Ni(ATMP) Complex (3:1 Ni:ATMP)

In a 20 mL vial, 0.475 g nickel (II) chloride hexahydrate was dissolved in 18 mL of methanol under stirring. ATMP solution (50% in water, 0.614 mL) was added dropwise to the methanol solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Cu(ATMP) Complex (3:1 Cu:ATMP)

In a 20 mL vial, 0.341 g copper (II) chloride dihydrate was dissolved in 18 mL of methanol under stirring. ATMP solution (50% in water, 0.614 mL) was added dropwise to the methanol solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Co(ATMP) Complex (3:1 Co:ATMP)

In a 20 mL vial, 0.260 g cobalt (II) chloride anhydrous was dissolved in 18 mL of methanol under stirring. ATMP solution (50% in water, 0.614 mL) was added dropwise to the methanol solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Example 7. Synthesis of Ce(ATMP) Complexes

### 2:1 Ce:ATMP (Ce³⁺)

In a 20 mL vial, 1.74 g cerium (III) nitrate hexahydrate was dissolved in 0.922 mL of 1M HCl in DI water under stirring. ATMP solution (50% in water, 0.922 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### 2:1 Ce:ATMP (Ce⁴⁺)

In a 20 mL vial, 2.19 g cerium (IV) ammonium nitrate was dissolved in 0.922 mL of 1M HCl in DI water under stirring ATMP solution (50% in water, 0.922 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### 3:1 Ce:ATMP

In a 20 mL vial, 1.74 g cerium (III) nitrate hexahydrate was dissolved in 0.922 mL of 1M HCl in DI water under stirring. ATMP solution (50% in water, 0.614 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### 3:1 Ce:ATMP (HNO₃ as Synthesis Acid)

In a 20 mL vial, 1.74 g cerium (III) nitrate hexahydrate was dissolved in 0.614 mL of 1M HNO₃ in DI water under stirring. ATMP solution (50% in water, 0.614 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C.

### 4:1 Ce:ATMP

In a 20 mL vial, 1.74 g cerium (III) nitrate hexahydrate was dissolved in 0.922 mL of 1M HCl in DI water under stirring. ATMP solution (50% in water, 0.461 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### 5:1 Ce:ATMP

In a 20 mL vial, 1.74 g cerium (III) nitrate hexahydrate was dissolved in 0.922 mL of 1M HCl in DI water under stirring. ATMP solution (50% in water, 0.369 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### 6:1 Ce:ATMP

In a 20 mL vial, 1.74 g cerium (III) nitrate hexahydrate was dissolved in 0.922 mL of 1M HCl in DI water under stirring. ATMP solution (50% in water, 0.307 mL) was added to a separate vial. The Ce salt solution was added dropwise to the ATMP solution. The reaction mixture was allowed to stir overnight at room temperature. Following the reaction completion, the reaction mixture was added to a centrifuge tube and centrifuged at 9000 RPM for 5 min. The solution phase was discarded and 5 mL of water was added to the tube. Centrifugation and washing were repeated 3 times. The resulting solids were dried at 80° C. overnight.

### Example 8. Casting Supported Membranes

### General Procedure

A MSK-AFA-III—HB tape casting coater system was use to cast PFSA membranes. The coating solution consisted of 10 wt. % PFSA dispersion (D2020 solution diluted with isopropanol 1:1) and between 0.1 wt. % and 0.5 wt. % metal complex in a water:isopropanol mixed solvent, such that solution contained 0.014 metal atoms per sulfonic acid moiety. The solution was homogenized at 9000 RPM for 2 min and sonicated for 30 min prior to use. The PFSA ink was cast directly on glass using blade-coating before ePTFE was laid on top of the wet ink. The resulting ePTFE impregnated with the PFSA ink was placed in a 180° C. oven for 3 minutes and allowed to cool to room temperature. A second deposition of ink was cast on top of the ePTFE using blade-coating. The ePTFE impregnated with the PFSA ink was again placed in a 180° C. oven for 3 minutes and allowed to cool to room temperature. The blade-coating was performed at 20 cm/min at room temperature.

### Membrane Comprising Ce(Mellitic Acid) Complex in PFSA

The general procedure described above was used with the coating solution comprising 0.41 wt. % of Ce (mellitic acid) complex (3:1 Ce:mellitic acid).

### Membrane Comprising Ce(EDTA) Complex in PFSA

The general procedure described above was used with the coating solution comprising 0.45 wt. % of Ce(EDTA) complex (3:1 Ce:EDTA).

### Membrane Comprising Ce(NTA) Complex in PFSA

The general procedure described above was used with the coating solution comprising 0.43 wt. % of Ce(NTA) complex (3:1 Ce:NTA).

### Membrane Comprising Ce(DTPMP) Complex in PFSA

The general procedure described above was used with the coating solution comprising 0.43 wt. % of Ce(DTPMP) complex (3:1 Ce:DTPMP).

### Membrane Comprising Cu(ATMP) Complex in PFSA

The general procedure described above was used with the coating solution comprising 0.21 wt. % of Cu(ATMP) complex.

### Membrane Comprising Fe(ATMP) Complex in PFSA

The general procedure described above was used with the coating solution comprising 0.29 wt. % of Fe(ATMP) complex.

### Membrane Comprising Co(ATMP) Complex in PFSA

The general procedure described above was used with the coating solution comprising 0.11 wt. % of Co(ATMP) complex.

### Membrane Comprising Ni(ATMP) Complex in PFSA

The general procedure described above was used with the coating solution comprising 0.11 wt. % of Ni(ATMP) complex.

The teachings of all patents, published applications and references cited herein are incorporated by reference in their entirety.

While this invention has been particularly shown and described with references to example embodiments thereof, it can be understood by those skilled in the art that various changes in form and details may be made therein without departing from the scope of the invention encompassed by the appended claims.

What is claimed is:

1. A polyelectrolyte membrane, comprising:
a polyelectrolyte and a metal complex, wherein:
the metal complex comprises a metal cation and a ligand; and
the ligand comprises three or more functional groups, wherein each functional group is independently selected from phosphonic acid, sulfonic acid, and carboxylic acid, or an anion thereof.

2. The polyelectrolyte membrane of claim 1, wherein the metal cation is selected from the cations of Ce, Sc, Y, Ti, Zr, Hf, V, Nb, Ta, Cr, Mo, W, Mn, Fe, Co, Ni, Sm, Gd, and Th.

3. The polyelectrolyte membrane of claim 2, wherein the metal cation is selected from the cations of Ce, Mn, and Zr.

4. The polyelectrolyte membrane of claim 2, wherein the metal cation is selected from the cations of Ce, Cu, Fe, Co, and Ni.

5. The polyelectrolyte membrane of claim 2, wherein the metal cation is a Ce cation.

6. The polyelectrolyte membrane of claim 5, wherein the Ce cation is Ce⁴⁺.

7. The polyelectrolyte membrane of claim 5, wherein the Ce cation is Ce³⁺.

8. The polyelectrolyte membrane of any one of claims 1-7, wherein the ligand is selected from aminotris(methylene phosphonic acid) (ATMP), diethylenetriaminepentakis(methylene phosphonic acid) (DTPMP), ethylenediamine tetra(methylene phosphonic acid) (EDTMP), hexamethylenediamine tetra(methylene phosphonic acid) (HDTMP), bis(hexamethylenetriamine penta(methylene phosphonic acid) (BHMTMP), benzene trisulfonic acid, naphthalene trisulfonic acid, pyrenetetrasulfonic acid, triphenylphosphine-3,3′,3″-trisulfonic acid, nitrilotriacetic acid (NTA), citric acid, ethylenediaminetetraacetic acid (EDTA), benzenetricarboxylic acid, benzenetetracarboxylic acid, benzenepentacarboxylic acid, benzene-1,3,5-triacetic acid, mellitic acid, N,N-Bis(phosphonomethyl)glycine, 2,2′-((phosphonomethyl) azanedi-yl)diacetic acid, ethylene glycol-bis(2-aminoethylether)-N,N,N′,N′-tetraacetic acid, 1,2-bis(2-aminophenoxy)ethane-N,N,N′,N′-tetraacetic acid, ethylenediamine-N,N′-disuccinic acid N-(2-hydroxyethyl)ethylenediamine-N,N′,N′-triacetic acid, 1,2-diaminopropane-N,N,N′,N′-tetraacetic acid, 1,2,3,4-butanetetracarboxylic acid, 1,3-diamino-2-hydroxypropane-N,N,N′,N′-tetraacetic acid, 1,6-diaminohexane-N,N,N′,N′-tetraacetic acid, 1,2-diaminocyclohexane-N,N,N′,N′-tetraacetic acid, and 3,3′-dimethoxybenzidine-N,N,N′,N′-tetraacetic acid, or is an anion thereof.

9. The polyelectrolyte membrane of claim 8, wherein the ligand is selected from ATMP, DTPMP, NTA, EDTA, and mellitic acid, or is an anion thereof.

10. The polyelectrolyte membrane of claim 8, wherein the ligand is ATMP or an anion thereof.

11. The polyelectrolyte membrane of any one of claims 1-10, wherein the metal complex comprises the metal cation and the ligand in a molar ratio from about 12:1 to about 1:1.

12. The polyelectrolyte membrane of claim 11, wherein the metal complex comprises the metal cation and the ligand in a molar ratio about 3:1.

13. The polyelectrolyte membrane of any one of claims 1-12, wherein the metal cation is Ce cation and the ligand is ATMP or an anion thereof.

14. The polyelectrolyte membrane of claim 13, wherein the metal complex comprises Ce cation and ATMP or an anion thereof in a molar ratio about 6:1.

15. The polyelectrolyte membrane of any one of claims 1-14, wherein the metal complex further comprises a complex anion.

16. The polyelectrolyte membrane of claim 15, wherein the complex anion is selected from NO₃⁻, Cl⁻, F⁻, BF₄⁻, SO₄²⁻, HSO₄⁻, [(NH₄)₂(NO₃)₆]²⁻, CO₃²⁻, HCO₃⁻, CH₃CO₂⁻ and HCO₂⁻.

17. The polyelectrolyte membrane of claim 16, wherein the complex anion is NO₃⁻ or Cl⁻.

18. The polyelectrolyte membrane of claim 16, wherein the complex anion is NO₃⁻.

19. The polyelectrolyte membrane of any one of claims 1-18, wherein the polyelectrolyte and the metal complex form an admixture.

20. The polyelectrolyte membrane of any one of claims 1-19, wherein the polyelectrolyte membrane comprises from about 0.1 wt. % to about 10 wt. % of the metal cation.

21. The polyelectrolyte membrane of claim 20, wherein the polyelectrolyte membrane comprises about 1 wt. % of the metal cation.

22. The polyelectrolyte membrane of any one of claims 1-21, wherein the polyelectrolyte is sulfonated.

23. The polyelectrolyte membrane of claim 22, wherein the polyelectrolyte is perfluorosulfonic acid (PFSA).

24. The polyelectrolyte membrane of claim 22, wherein the polyelectrolyte is selected from sulfonated polyphenyl sulfone (sPPS), sulfonated polyether ether ketone (sPEEK), sulfonated polyphosphazene (sPOP), sulfonated polybenzimidazole (sPBI), sulfonated polyether sulfone (sPES), sulfonated polyphenylene oxide (sPPO), sulfonated polyarylene ether ketone (sPAEK), sulgonated polyphenyl sulfone, sulfonated poly(sulfone), sulfonated poly(sulfide sulfone), sulfonated polyimide (sPI), sulfonated poly(etherimide) (sPEI), sulfonated poly(amine), sulfo-phenylated polyphenylene, and sulfonated polyetherpyridine, or is a combination thereof.

25. The polyelectrolyte membrane of claim 24, wherein the polyelectrolyte is sPPS.

26. The polyelectrolyte membrane of any one of claims 22-25, wherein the degree of sulfonation of the polyelectrolyte is from about 100% to about 300%.

27. The polyelectrolyte membrane of claim 26, wherein the degree of sulfonation of the polyelectrolyte is about 200%.

28. The polyelectrolyte membrane of any one of claims 1-27, wherein:
the polyelectrolyte comprises a plurality of sulfonic acid moieties, and
the polyelectrolyte membrane comprises from about 0.0001 to about 0.1 metal cations per sulfonic acid moiety.

29. The polyelectrolyte membrane of claim 28, wherein the polyelectrolyte membrane comprises about 0.014 metal cations per sulfonic acid moiety.

30. The polyelectrolyte membrane of any one of claims 1-29, wherein the polyelectrolyte is crosslinked.

31. The polyelectrolyte membrane of claim 30, wherein the polyelectrolyte comprises a crosslinking moiety represented by one of the following structural formulas: 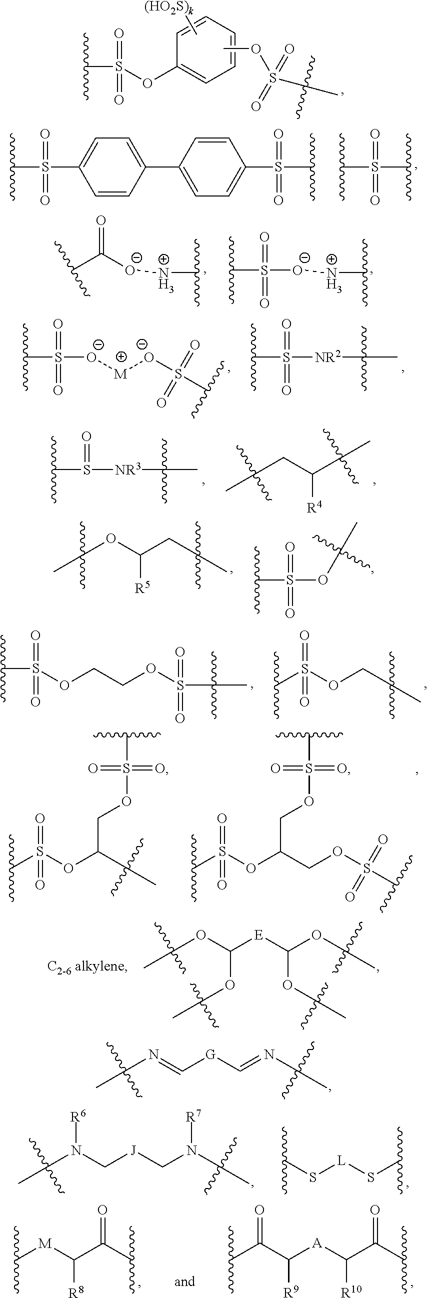
and wherein:
k is 0, 1, or 2;
each of R², R³, R⁴, R⁵, R⁶, R⁷, R⁸, R⁹, and R¹⁰ is independently selected from H, C₁₋₁₂ alkyl, C₁₋₁₂ haloalkyl, C₆₋₁₄ aryl, and C₆₋₁₄ aryl(C₁₋₁₂ alkylene);
each of A, E, G, J, L, and Mis independently selected from a bond, C₁₋₁₂ alkylene, and C₆₋₁₄ arylene;
each of R^{a} and R^{a*} is independently H or C₁₋₁₂ alkyl;
M²⁺ is selected from Mg²⁺, Ca²⁺, Ba²⁺, and Al(X)²⁺, wherein X is a halide, acetate, or nitrate; and
the symbol “ [symbol] ” represents a point of attachment of the crosslinking moiety to a repeat unit of the polyelectrolyte.

32. The polyelectrolyte membrane of claim 31, wherein the crosslinking moiety is represented by one of the following structural formulas:

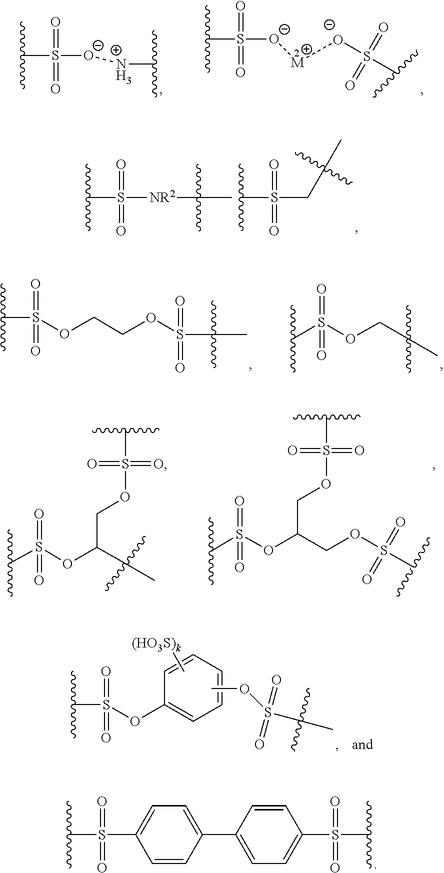

33. The polyelectrolyte membrane of claim 31, wherein the crosslinking moiety is represented by one of the following structural formulas:

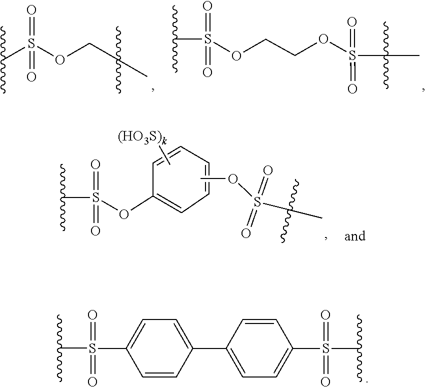

34. The polyelectrolyte membrane of claim 31, wherein the crosslinking moiety is represented by the following structural formula:

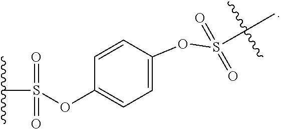 [SMILES: *S(=O)(=O)Oc1ccc(OS(*)(=O)=O)cc1]

35. The polyelectrolyte membrane of any one of claims 30-34, wherein the degree of crosslinking of the polyelectrolyte is from about 10% to about 95%.

36. The polyelectrolyte membrane of claim 35, wherein the degree of crosslinking of the polyelectrolyte is from about 30% to about 50%.

37. The polyelectrolyte membrane of claim 1, wherein:
the metal cation is Ce cation;
the ligand is selected from ATMP, DTPMP, NTA, EDTA, and mellitic acid, or is an anion thereof; and
the polyelectrolyte is PFSA.

38. The polyelectrolyte membrane of claim 1, wherein:
the metal cation is selected from cations of Ce, Cu, Fe, Co, and Ni;
the ligand is ATMP; and
the polyelectrolyte is PFSA.

39. The polyelectrolyte membrane of claim 1, wherein:
the metal cation is selected from cations of Ce, Zr, and Mn;
the ligand is ATMP; and
the polyelectrolyte comprises sPPS.

40. The polyelectrolyte membrane of claim 38 or 39, wherein the metal cation is a Ce cation.

41. The polyelectrolyte membrane of claim 39, wherein the sPPS is crosslinked sPPS.

42. The polyelectrolyte membrane of claim 41, wherein the crosslinked sPPS comprises a crosslinking moiety represented by the following structural formula:

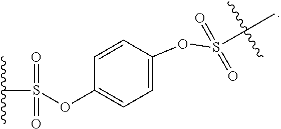 [SMILES: *S(=O)(=O)Oc1ccc(OS(*)(=O)=O)cc1]

43. The polyelectrolyte membrane of claim 1, wherein:
the metal cation is Ce cation;
the ligand is ATMP;
the metal complex further comprises NO₃⁻;
Ce cation and ATMP are present in a molar ratio of about 3:1; and
the polyelectrolyte is sPPS.

44. The polyelectrolyte membrane of any one of claims 1-43, wherein the membrane is a free-standing membrane consisting of the polyelectrolyte and the metal complex.

45. The polyelectrolyte membrane of any one of claims 1-44, wherein the polyelectrolyte membrane is from about 2 μm to about 100 μm thick.

46. The polyelectrolyte membrane of any one of claims 1-43, wherein the polyelectrolyte membrane further comprises a support polymer.

47. The polyelectrolyte membrane of claim 46, comprising a porous matrix, wherein:
the porous matrix comprises the support polymer; and
the metal complex and the polyelectrolyte are dispersed in the porous matrix.

48. The composite membrane of claim 46 or 47, wherein the support polymer is polytetrafluoroethylene (PTFE).

49. The composite membrane of claim 48, wherein the PTFE is expanded PTFE.

50. The polyelectrolyte membrane of any one of claims 46-59, wherein the polyelectrolyte membrane is from about 0.5 μm to about 100 μm thick.

51. The composite membrane of claim 50, wherein the polyelectrolyte membrane is about 8 μm thick.

52. A method of making the polyelectrolyte membrane of any one of claims 1-45, comprising:
(a) providing a casting surface and a suspension comprising a metal complex, a polyelectrolyte, and (i) a crosslinking reagent, and/or (ii) a crosslinking initiator;
(b) depositing the suspension on the casting surface, thereby providing a membrane layer; and
(c) exposing the membrane layer to conditions sufficient for (i) the polyelectrolyte and the crosslinking reagent to undergo a crosslinking reaction, or (ii) the crosslinking initiator to initiate the crosslinking of the of the polyelectrolyte, thereby providing the polyelectrolyte membrane.

53. The method of claim 52, wherein the suspension comprises from about 0.01 wt. % to about 10 wt. % of the metal complex.

54. The method of claim 53, wherein the suspension comprises about 0.1 wt. % to about 1 wt. % of the metal complex.

55. The method of any one of claims claim 52-54, wherein the suspension comprises from about 2 wt. % to about 50 wt. % of the polyelectrolyte.

56. The method of claim 55, wherein the suspension comprises about 10 wt. % of the polyelectrolyte.

57. The method of any one of claims 52-56, wherein the polyelectrolyte comprises a crosslinkable group.

58. The method of claim 57, wherein the crosslinkable group is selected from OH, NH₂, NH, SH, C(O)OH, C(O)Cl, C(O)Br, NHNH₂, N₃, S(O)₂OH, S(O)₂Cl, —NCO,

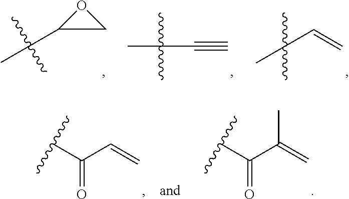

59. The method of any one of claims 52-58, wherein the suspension comprises the crosslinking initiator.

60. The method of claim 59, wherein the crosslinking initiator is selected from 2,2-dimethoxy-2-phenylacetophenone (DMPA), azobisisobutyronitrile (AIBN), and benzoyl peroxide (BPO).

61. The method of claim 59 or 60, wherein the conditions sufficient for the crosslinking initiator to initiate the crosslinking of the polyelectrolyte comprise visible light irradiation, UV light irradiation, application of heat, microwave irradiation, application of ultrasound, or gamma-ray irradiation.

62. The method of any one of claims 52-61, wherein the suspension comprises the crosslinking reagent.

63. The method of claim 62, wherein the conditions sufficient for the polyelectrolyte and the crosslinking reagent to undergo a crosslinking reaction comprise visible light irradiation, UV light irradiation, application of heat, microwave irradiation, or application of ultrasound.

64. The method of any one of claims 52-63, wherein the crosslinking reagent is selected from a polyalcohol, an aldehyde, an amine, an epoxide, a thiol, or a compound comprising a terminal alkene or alkyne.

65. The method of any one of claims 52-63, wherein the crosslinking reagent is selected from glycerol, ethylene glycol, hydroquinone, 2,5-dihydroxybenzenesulfonic acid, 2,5-dihydroxybenzene-1,4-disulfonic acid, biphenyl, tetraglycidyl bis(p-aminophenyl) methane, phenylene diamine, 4,4′-thiobisbenzenethiol, and tetrafluoro styrene.

66. A method of making the polyelectrolyte membrane of any one of claims 47-51, comprising:
(a) providing a porous matrix and a suspension comprising a metal complex and a polyelectrolyte;
(b) contacting the porous matrix with the suspension, thereby providing an impregnated porous matrix; and
(c) drying the impregnated porous matrix, thereby providing the polyelectrolyte membrane.

67. The method of claim 66, wherein the suspension further comprises a solvent comprising a water and alcohol.

68. The method of claim 66 or 67, wherein the suspension comprises from about 0.01 wt. % to about 10 wt. % of the metal complex.

69. The method of claim 68, wherein the suspension comprises from about 0.1 wt. % to about 1 wt. % of the metal complex.

70. The method of any one of claims claim 66-69, wherein the suspension comprises from about 2 wt. % to about 50 wt. % of the polyelectrolyte.

71. The method of claim 70, wherein the suspension comprises about 10 wt. % of the polyelectrolyte.

72. The method of any one of claims 66-71, wherein the polyelectrolyte comprises a crosslinkable group.

73. The method of claim 72, wherein the crosslinkable group is selected from OH, NH₂, NH, SH, C(O)OH, C(O)Cl, C(O)Br, NHNH₂, N₃, S(O)₂OH, S(O)₂Cl, —NCO,

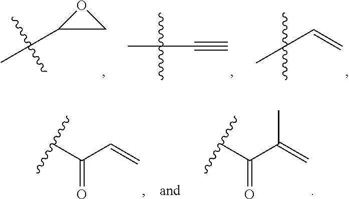

74. The method of any one of claims 66-73, wherein the suspension further comprises a crosslinking initiator.

75. The method of claim 74, further comprising a step of crosslinking the polyelectrolyte under conditions sufficient for the crosslinking initiator to initiate the crosslinking of the first polymer.

76. The method of claim 75, wherein the conditions sufficient for the crosslinking initiator to initiate the crosslinking of the polyelectrolyte comprise visible light irradiation, UV light irradiation, application of heat, microwave irradiation, application of ultrasound, or gamma-ray irradiation.

77. The method of any one of claims 74-76, wherein the crosslinking initiator is selected from 2,2-dimethoxy-2-phenylacetophenone (DMPA), azobisisobutyronitrile (AIBN), and benzoyl peroxide (BPO).

78. The method of any one of claims 66-77, wherein the suspension further comprises a crosslinking reagent.

79. The method of any one of claims 66-78, further comprising a step comprising reacting the polyelectrolyte with the crosslinking reagent under conditions sufficient for the polyelectrolyte and the crosslinking reagent to undergo a crosslinking reaction.

80. The method of claim 79, wherein the conditions sufficient for the polyelectrolyte and the crosslinking reagent to undergo a crosslinking reaction comprise visible light irradiation, UV light irradiation, application of heat, microwave irradiation, or application of ultrasound.

81. The method of any one of claims 78-80, wherein the crosslinking reagent is selected from a polyalcohol, an aldehyde, an amine, an epoxide, a thiol, or a compound comprising a terminal alkene or alkyne.

82. The method of any one of claims 78-81, wherein the crosslinking reagent is selected from glycerol, ethylene glycol, hydroquinone, 2,5-dihydroxybenzenesulfonic acid, 2,5-dihydroxybenzene-1,4-disulfonic acid, biphenyl, tetraglycidyl bis(p-aminophenyl) methane, phenylene diamine, 4,4′-thiobisbenzenethiol, and tetrafluoro styrene.

83. A membrane electrode assembly (MEA), comprising:
a polyelectrolyte membrane of any one of claims 1-51;
a cathode; and
an anode,
wherein the polyelectrolyte membrane or the polyelectrolyte membrane is disposed between the anode and the cathode.

84. A fuel cell, comprising one or more of the MEAs of claim 83 and one or more gas flow bipolar plates.
